(19) United States
(12) Patent Application Publication
(10) Pub. No.: US 2017/0369633 A1
(43) Pub. Date: Dec. 28, 2017

(54) CURABLE AND CURED EPOXY RESIN COMPOSITIONS

(71) Applicant: 3M INNOVATIVE PROPERTIES COMPANY, St. Paul, MN (US)

(72) Inventors: Mary M. Caruso Dailey, Maplewood, MN (US); Hassan Sahouani, Hastings, MN (US); Luke E. Heinzen, Shoreview, MN (US); Sohaib Elgimiabi, Dusseldorf (DE); Ying Lin, Woodbury, MN (US)

(21) Appl. No.: 15/533,844

(22) PCT Filed: Dec. 14, 2015
(86) PCT No.: PCT/US2015/065549

§ 371 Date: Jun. 7, 2017

Related U.S. Application Data
(60) Provisional application No. 62/095,963, filed on Dec. 23, 2014.

(51) Int. Cl. C08G 59/18; C08J 3/24

(52) U.S. Cl. CPC C08G 59/188; C08J 3/242; C08J 3/241; C08J 2363/00

(57) ABSTRACT

Curable epoxy resin compositions are provided that are mixtures containing an epoxy resin and composite particles. The composite particles have a porous polymeric core, a nitrogen-based curing agent for an epoxy resin positioned within the porous polymeric core, and a coating layer around the porous polymeric core. The nitrogen-containing curing agent typically does not react with the epoxy resin until the curable composition is heated causing the release of the nitrogen-containing curing agent from the composite particle. Additionally, cured epoxy resins formed from the curable composition and method of forming cured epoxy resins are provided.

### CROSS REFERENCE TO RELATED APPLICATION

This application claims priority to U.S. Provisional Patent Application 62/095963, filed on Dec. 23, 2014, the disclosure of which is incorporated by reference in its entirety.

### FIELD

Curable epoxy resin compositions, cured epoxy resin compositions, and methods of making the cured epoxy resin compositions are described.

### BACKGROUND

Curable epoxy compositions are often provided as a two-part formulation in which the epoxy resin is separated from the curing agent until immediately prior to the formation of a cured composition. Once mixed, the curing agent and the epoxy resin react quickly at room or elevated temperatures. Such curable epoxy compositions tend to have good storage stability (such as one year or more) but need to be used soon after the part containing the epoxy resin is mixed with the part containing the curing agent. Further, the two parts must be carefully metered together for mixing so the amount of the epoxy resin and curing agent are appropriate.

Some one-part compositions are known in which a latent curing agent is used. Although no mixing is required, the shelf-life of one-part systems typically is significantly reduced compared to two-part formulations. Shelf-lives of 6 months or more can be achieved through the use of latent curing agents that are thermally activated to form the cured composition. The cure temperature is often limited by the melting point of the curing agent, which typically exceeds about 170° C. for conventional latent curing agent. The use of various accelerants such as urea-based compounds and imidazole-based compounds have been used to lower the temperatures needed for curing.

### SUMMARY

Curable epoxy resin compositions are provided that are mixtures containing an epoxy resin and composite particles. The composite particles have a porous polymeric core, a nitrogen-based curing agent for an epoxy resin positioned within the porous polymeric core, and a coating layer around the porous polymeric core. The nitrogen-containing curing agent typically does not react with the epoxy resin until the curable composition is heated causing the release of the nitrogen-containing curing agent from the composite particle. Additionally, cured epoxy resins formed from the curable composition and methods of forming cured epoxy resins are provided.

In a first aspect, a curable composition is provided. The curable composition contains an epoxy resin and a composite particle mixed with the epoxy resin. The composite particle contains 1) a porous polymeric core, 2) a nitrogen-containing curing agent for the epoxy resin that is positioned within the porous polymeric core but not covalently bound to the porous polymeric core, and 3) a coating layer around the porous polymeric core, wherein the coating layer comprises a thermoplastic polymer, a wax, or a mixture thereof.

In a second aspect, a cured composition is provided. The cured composition is a reaction product of the curable composition described above.

In a third aspect, a method of forming a cured composition is provided. The method includes providing a curable composition that is the same as described above, heating the curable composition to release the nitrogen-containing curing agent from the composite particle, and reacting the nitrogen-containing curing agent with the epoxy resin.

### BRIEF DESCRIPTION OF THE DRAWINGS

FIGS. 1A and 1B are scanning electron microscopy (SEM) images of example core particles that were formed according to Preparatory Example 1. These two SEM images have different degrees of magnification.

FIG. 2 is the SEM image of example composite particles that were prepared according to Example 1.

FIG. 3 shows the Differential Scanning calorimetry (DSC) plots of heat flow versus temperature for an example nitrogen-containing curing agent (which was 4,4′-methylene bis(phenyl dimethyl) urea available from CVC Specialty Chemicals, Inc. (Moorestown, N.J., USA) under the trade designation OMICURE U52M), for example core particles, and for example composite particles that are loaded with the same nitrogen-containing curing agent.

FIG. 4 is the SEM image of other example composite particles that were formed according to Example 6.

### DETAILED DESCRIPTION

Curable epoxy resin compositions, cured epoxy resin compositions formed from the curable epoxy resin compositions, and methods of making cured epoxy resin compositions are provided. The curable epoxy resin compositions are one-part formulations that contain both an epoxy resin and composite particles mixed with the epoxy resin. The composite particles include a nitrogen-containing curing agent that can be released from the composite particles when heated above a certain temperature. The released nitrogen-containing curing agent can react with the epoxy resin to form a cured epoxy composition. The curable epoxy resin compositions can have excellent storage stability.

As used herein, the terms “polymer”, “polymeric”, and “polymeric material” are used interchangeably to refer to a homopolymer, copolymer, terpolymer, or the like.

As used herein, the term “and/or” means one or both. For example, the expression thermoplastic polymer and/or wax refers to a thermoplastic polymer alone, a wax alone, or to both a thermoplastic polymer and a wax.

The epoxy resin that is included in the curable epoxy resin composition contains at least one epoxy functional group (i.e., oxirane group) per molecule. As used herein, the term oxirane group refers to the following divalent group.

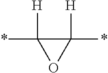 [SMILES: *C1OC1*]

The asterisks denote a site of attachment of the oxirane group to another group. If the oxirane group is at the terminal position of the epoxy resin, the oxirane group is typically bonded to a hydrogen atom.

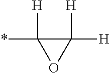 [SMILES: *C1CO1]

This terminal oxirane group is often part of a glycidyl group.

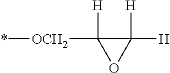

The epoxy resin has at least one oxirane group per molecule and often has at least two oxirane groups per molecule. For example, the epoxy resin can have 1 to 10, 2 to 10, 1 to 6, 2 to 6, 1 to 4, or 2 to 4 oxirane groups per molecule. The oxirane groups are usually part of a glycidyl group.

Epoxy resins can be a single material or a mixture of materials selected to provide the desired viscosity characteristics before curing and to provide the desired mechanical properties after curing. If the epoxy resin is a mixture of materials, at least one of the epoxy resins in the mixture is usually selected to have at least two oxirane groups per molecule. For example, a first epoxy resin in the mixture can have two to four or more oxirane groups and a second epoxy resin in the mixture can have one to four oxirane groups. In some of these examples, the first epoxy resin is a first glycidyl ether with two to four glycidyl groups and the second epoxy resin is a second glycidyl ether with one to four glycidyl groups.

The portion of the epoxy resin molecule that is not an oxirane group (i.e., the epoxy resin molecule minus the oxirane groups) can be aromatic, aliphatic or a combination thereof and can be linear, branched, cyclic, or a combination thereof The aromatic and aliphatic portions of the epoxy resin can include heteroatoms or other groups that are not reactive with the oxirane groups. That is, the epoxy resin can include halo groups, oxy groups such as in an ether linkage group, thio groups such as in a thio ether linkage group, carbonyl groups, carbonyloxy groups, carbonylimino groups, phosphono groups, sulfono groups, nitro groups, nitrile groups, and the like. The epoxy resin can also be a silicone-based material such as a polydiorganosiloxane-based material.

Although the epoxy resin can have any suitable molecular weight, the weight average molecular weight is usually at least 100 grams/mole, at least 150 grams/mole, at least 175 grams/mole, at least 200 grams/mole, at least 250 grams/mole, or at least 300 grams/mole. The weight average molecular weight can be up to 50,000 grams/mole or even higher for polymeric epoxy resins. The weight average molecular weight is often up to 40,000 grams/mole, up to 20,000 grams/mole, up to 10,000 grams/mole, up to 5,000 grams/mole, up to 3,000 grams/mole, or up to 1,000 grams/mole. For example, the weight average molecular weight can be in the range of 100 to 50,000 grams/mole, in the range of 100 to 20,000 grams/mole, in the range of 10 to 10,000 grams/mole, in the range of 100 to 5,000 grams/mole, in the range of 200 to 5,000 grams/mole, in the range of 100 to 2,000 grams/mole, in the range of 200 to 2,000 grams/mole, in the range of 100 to 1,000 grams/mole, or in the range of 200 to 1,000 grams/mole.

Suitable epoxy resins are typically a liquid at room temperature (e.g., about 20° C. to about 25° C. or about 20° C. to about 30° C.). However, epoxy resins that can be dissolved in a suitable organic solvent also can be used. In most embodiments, the epoxy resin is a glycidyl ether. Exemplary glycidyl ethers can be of Formula (I).

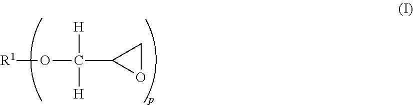

In Formula (I), group R¹ is a p-valent group that is aromatic, aliphatic, or a combination thereof. Group R¹ can be linear, branched, cyclic, or a combination thereof. Group R² can optionally include halo groups, oxy groups, thio groups, carbonyl groups, carbonyloxy groups, carbonylimino groups, phosphono groups, sulfono groups, nitro groups, nitrile groups, and the like. Although the variable p can be any suitable integer greater than or equal to 1, p is often an integer in the range of 2 to 10, in the range of 2 to 6, or in the range of 2 to 4.

In some exemplary epoxy resins of Formula (I), the variable p is equal to 2 (i.e., the epoxy resin is a diglycidyl ether) and R² includes an alkylene (i.e., an alkylene is a divalent radical of an alkane and can be referred to as an alkane-diyl), heteroalkylene (i.e., a heteroalkylene is a divalent radical of a heteroalkane and can be referred to as a heteroalkane-diyl), arylene (i.e., a divalent radical of an arene compound), or combination thereof. Suitable alkylene groups often have 1 to 20 carbon atoms, 1 to 12 carbon atoms, 1 to 8 carbon atoms, or 1 to 4 carbon atoms. Suitable heteroalkylene groups often have 2 to 50 carbon atoms, 2 to 40 carbon atoms, 2 to 30 carbon atoms, 2 to 20 carbon atoms, 2 to 10 carbon atoms, or 2 to 6 carbon atoms with 1 to 10 heteroatoms, 1 to 6 heteroatoms, or 1 to 4 heteroatoms. The heteroatoms in the heteroalkylene can be selected from oxy, thio, or —NH— groups but are often oxy groups. Suitable arylene groups often have 6 to 18 carbon atoms or 6 to 12 carbon atoms. For example, the arylene can be phenylene or biphenylene. Group R¹ can further optionally include halo groups, oxy groups, thio groups, carbonyl groups, carbonyloxy groups, carbonylimino groups, phosphono groups, sulfono groups, nitro groups, nitrile groups, and the like. The variable p is usually an integer in the range of 2 to 4.

Some epoxy resins of Formula (I) are diglycidyl ethers where R¹ includes (a) an arylene group or (b) an arylene group in combination with an alkylene, heteroalkylene, or both. Group R² can further include optional groups such as halo groups, oxy groups, thio groups, carbonyl groups, carbonyloxy groups, carbonylimino groups, phosphono groups, sulfono groups, nitro groups, nitrile groups, and the like. These epoxy resins can be prepared, for example, by reacting an aromatic compound having at least two hydroxyl groups with an excess of epichlorohydrin. Examples of useful aromatic compounds having at least two hydroxyl groups include, but are not limited to, resorcinol, catechol, hydroquinone, p,p′-dihydroxydibenzyl, p,p′-dihydroxyphenylsulfone, p,p′-dihydroxybenzophenone, 2,2′-dihydroxyphenyl sulfone, and p,p′-dihydroxybenzophenone. Still other examples include the 2,2′, 2,3′, 2,4′, 3,3′, 3,4′, and 4,4′ isomers of dihydroxydiphenylmethane, dihydroxydiphenyldimethylmethane, dihydroxydiphenylethylmethylme thane, dihydroxydiphenylme thylpropylmethane, dihydroxydiphenylethylphenylmethane, dihydroxydiphenylpropylenphenylmethane, dihydroxydiphenylbutylphenylmethane, dihydroxydiphenyltolyle thane, dihydroxydiphenyltolylmethylmethane, dihydroxydiphenyldicyclohexylmethane, and dihydroxydiphenylcyclohexane.

Some commercially available diglycidyl ether epoxy resins of Formula (I) are derived from bisphenol A (i.e., bisphenol A is 4,4′-dihydroxydiphenylmethane). Examples include, but are not limited to, those available under the trade designation EPON (e.g., EPON 828, EPON 872, EPON 1001, EPON 1004, EPON 2004, EPON 1510, and EPON 1310) from Momentive Specialty Chemicals, Inc. in Columbus, Ohio, USA, those available under the trade designation DER (e.g., DER 331, DER 332, DER 336, and DER 439) from Dow Chemical Co. in Midland, Mich., USA and those available under the trade designation EPICLON (e.g., EPICLON 850) from Dainippon Ink and Chemicals, Inc. in Chiba, Japan. Other commercially available diglycidyl ether epoxy resins are derived from bisphenol F (i.e., bisphenol F is 2,2′-dihydroxydiphenylmethane). Examples include, but are not limited to, those available under the trade designation DER (e.g., DER 334) from Dow Chemical Co., those available under the trade designation EPICLON (e.g., EPICLON 830) from Dainippon Ink and Chemicals, Inc. in Parsippany, N.J., USA, and those available under the trade designation ARALDITE (e.g., ARALDITE GY 281) from Huntsman Corporation in The Woodlands, Tex., USA.

Other epoxy resins of Formula (I) are diglycidyl ethers of a poly(alkylene oxide) diol. These epoxy resins also can be referred to as diglycidyl ethers of a poly(alkylene glycol) diol. The variable p is equal to 2 and R¹ is a heteroalkylene having oxygen heteroatoms. The poly(alkylene glycol) portion can be a copolymer or homopolymer and often include alkylene units having 1 to 4 carbon atoms. Examples include, but are not limited to, diglycidyl ethers of poly(ethylene oxide) diol, diglycidyl ethers of poly(propylene oxide) diol, and diglycidyl ethers of poly(tetramethylene oxide) diol. Epoxy resins of this type are commercially available from Polysciences, Inc. in Warrington, Pa., USA such as those derived from a poly(ethylene oxide) diol or from a poly(propylene oxide) diol having a weight average molecular weight of about 400 grams/mole, about 600 grams/mole, or about 1000 grams/mole.

Still other epoxy resins of Formula (I) are diglycidyl ethers of an alkane diol (R1² is an alkylene and the variable p is equal to 2). Examples include a diglycidyl ether of 1,4-dimethanol cyclohexyl, diglycidyl ether of 1,4-butanediol, and a diglycidyl ether of the cycloaliphatic diol formed from a hydrogenated bisphenol A such as those commercially available under the trade designation EPONEX (e.g., EPONEX 1510) from Hexion Specialty Chemicals, Inc. (Columbus, Ohio) and under the trade designation EPALLOY (e.g., EPALLLOY 5001) from CVC Thermoset Specialties (Moorestown, N.J.).

For some applications, the epoxy resins chosen for use in the curable coating compositions are novolac epoxy resins, which are glycidyl ethers of phenolic novolac resins. These resins can be prepared, for example, by reaction of phenols with an excess of formaldehyde in the presence of an acidic catalyst to produce the phenolic novolac resin. Novolac epoxy resins are then prepared by reacting the phenolic novolac resin with epichlorihydrin in the presence of sodium hydroxide. The resulting novolac epoxy resins typically have more than two oxirane groups and can be used to produce cured coating compositions with a high crosslinking density. The use of novolac epoxy resins can be particularly desirable in applications where corrosion resistance, water resistance, chemical resistance, or a combination thereof is desired. One such novolac epoxy resin is poly[(phenyl glycidyl ether)-co-formaldehyde]. Other suitable novolac resins are commercially available under the trade designation ARALDITE (e.g., ARALDITE GY289, ARALDITE EPN 1183, ARALDITE EP 1179, ARALDITE EPN 1139, and ARALDITE EPN 1138) from Huntsman Corporation in The Woodlands, Tex., USA under the trade designation EPALLOY (e.g., EPALLOY 8230) from CVC Thermoset Specialties in Moorestown, N.J., USA and under the trade designation DEN (e.g., DEN 424 and DEN 431) from Dow Chemical in Midland, Mich., USA.

Yet other epoxy resins include silicone resins with at least two glycidyl groups and flame retardant epoxy resins with at least two glycidyl groups (e.g., a brominated bisphenol-type epoxy resin having at least two glycidyl groups such as that commercially available from Dow Chemical Co. in Midland, MI, USA under the trade designation DER 580).

The epoxy resin is often a mixture of materials. For example, the epoxy resins can be selected to be a mixture that provides the desired viscosity or flow characteristics prior to curing. The mixture can include at least one first epoxy resin that is referred to as a reactive diluent that has a lower viscosity and at least one second epoxy resin that has a higher viscosity. The reactive diluent tends to lower the viscosity of the epoxy resin composition and often has either a branched backbone that is saturated or a cyclic backbone that is saturated or unsaturated. Examples include, but are not limited to, the diglycidyl ether of resorcinol, the diglycidyl ether of cyclohexane dimethanol, the diglycidyl ether of neopentyl glycol, and the triglycidyl ether of trimethylolpropane. Diglycidyl ethers of cyclohexane dimethanol are commercially available under the trade designation HELOXY MODIFIER (e.g., HELOXY MODIFIER 107) from Hexion Specialty Chemicals in Columbus, Ohio, USA and under the trade designation EPODIL (e.g., EPODIL 757) from Air Products and Chemicals, Inc. in Allentown, Pa., USA. Other reactive diluents have only one functional group (i.e., oxirane group) such as various monoglycidyl ethers. Some example monoglycidyl ethers include, but are not limited to, alkyl glycidyl ethers with an alkyl group having 1 to 20 carbon atoms, 1 to 12 carbon atoms, 1 to 8 carbon atoms, or 1 to 4 carbon atoms. Some monoglycidyl ethers that are commercially available include those under the trade designation EPODIL from Air Products and Chemicals, Inc. in Allentown, Pa., USA such as EPODIL 746 (2-ethylhexyl glycidyl ether), EPODIL 747 (aliphatic glycidyl ether), and EPODIL 748 (aliphatic glycidyl ether).

Still other epoxy resins are designed to reduce amine blushing. These epoxy resins are usually added into the curable coating compositions at relatively low levels. Such an epoxy resin is commercially available under the trade designation DW 1765 from Huntsman Corporation, The Woodlands, Tex., USA. This material has a paste-like consistency but is based on a liquid epoxy resin.

The curable coating composition typically includes at least 20 weight percent epoxy resin based on a combined weight of the first part and the second part of the curable coating composition (i.e., based on a total weight of the curable coating composition). If lower levels are used, the cured coating composition may not contain enough polymeric material (e.g., epoxy resin) to provide the desired coating characteristics. Some curable coating composition can include at least 25 weight percent, at least 30 weight percent, at least 40 weight percent, or at least 50 weight percent epoxy resin. The curable coating composition often includes up to 80 weight percent epoxy resin but higher amounts could be used if no fillers are added. For example, the curable coating composition can include up to 75 weight percent, up to 70 weight percent, up to 65 weight percent, or up to 60 weight percent epoxy resin. Some examples of curable coating compositions contain 20 to 80 weight percent, 20 to 70 weight percent, 30 to 90 weight percent, 30 to 80 weight percent, 30 to 70 weight percent, 30 to 60 weight percent, 40 to 90 weight percent, 40 to 80 weight percent, 40 to 70 weight percent, 40 to 60 weight percent, 50 to 80 weight percent, or 50 to 70 weight percent epoxy resin.

The curable compositions include composite particles mixed with the epoxy resin. The composite particles contain 1) a porous polymeric core, 2) a nitrogen-containing curing agent positioned within the porous polymeric core but not covalently bonded to the porous polymeric core, and 3) a coating layer around the porous polymeric core. The nitrogen-containing curing agent can be released from the composite particle by diffusing out of the porous polymeric core through the coating layer when the curable composition is heated such as at a temperature above room temperature. The released nitrogen-containing curing agent can then react with the epoxy resin resulting in the formation of a cured composition.

The composite particles have a porous polymeric core. The polymeric core has pores (i.e., voids or free volume) on its outer surface and/or channels into the interior region. In at least some embodiments, the polymeric core is hollow. The terms “porous polymeric core”, “porous polymeric core particle”, “polymeric core”, “polymeric core particle”, “core particle”, and “core” are used interchangeably. The porous polymeric core is loaded with a nitrogen-containing curing agent, which can be referred to interchangeably as a “loaded core particle” and “loaded porous polymeric core particle” and “loaded polymeric core particle”. The terms “porous composite particle” and “composite particle” are used interchangeably and refer to the loaded core particle that is coated with a thermoplastic or wax. Because the composite particles include the porous polymeric core, the composite particles themselves can be considered to be porous.

Any suitable porous polymeric core can be used but the porous polymeric core is typically formed from a crosslinked (meth)acrylate polymeric material. The porous polymeric core particle is typically formed from a reaction mixture that includes a first phase and a second phase dispersed (e.g., as droplets) in the first phase with the volume of the first phase being greater than a volume of the second phase. That is, the first phase can be considered to be the continuous phase and the second phase can be considered to be the dispersed phase within the continuous phase. The first phase provides a non-polymerizable medium for suspending the second phase as droplets within the reaction mixture. The second phase droplets include a monomer composition that can undergo polymerization plus a porogen, which is poly(propylene glycol).

In many embodiments, the porous polymeric core contains a polymerized product of a reaction mixture that includes i) a first phase and ii) a second phase dispersed (e.g., as droplets) in the first phase, wherein a volume of the first phase is greater than a volume of the second phase. The first phase includes either 1) water and a polysaccharide dissolved in the water or 2) a surfactant and a compound of Formula (I)

HO(—CH₂—CH(OH)—CH₂—O)ₙ—H (I)

where the variable n is an integer equal to at least 1. The second phase includes 1) a monomer composition comprising a first monomer of Formula (II)

CH₂═C(R¹)—(CO)—O[—CH₂—CH₂—O]ₚ—(CO)—C(R¹)═CH₂ (II)

wherein p is an integer equal to at least land R¹ is hydrogen or alkyl and 2) a poly(propylene glycol) having a weight average molecular weight of at least 500 grams/mole, wherein the poly(propylene glycol) is removed from the polymerized product to provide the porous polymeric core.

The first phase of the reaction mixture typically includes either 1) water and a polysaccharide dissolved in the water or 2) a surfactant and a compound of Formula (I).

HO[—CH₂—CH(OH)—CH₂—O]ₙ—H (I)

The variable n in Formula (I) is an integer equal to at least 1. The first phase is typically formulated to provide a suitable viscosity and volume for dispersion of the second phase as droplets within the first phase. If the viscosity of the first phase is too high, it can be difficult to provide the requisite shear to disperse the second phase. If the viscosity is too low, however, it can be difficult to suspend the second phase and/or to form polymeric cores that are relatively uniform and well separated from each other.

In some embodiments, the first phase contains a mixture of water and a polysaccharide dissolved in the water. The polysaccharide can be, for example, a water soluble starch or water soluble cellulose.

Suitable water soluble starches and water soluble celluloses often have a viscosity in range of 6 to 10 centipoise for a 2 weight percent solution in water at room temperature (i.e., 20° C. to 25° C.). Water soluble starches are typically prepared by partial acid hydrolysis of starch. Examples of water soluble starches include those, for example, that are commercially available under the trade designation LYCOAT from Roquette (Lestrem, France). Examples of water soluble celluloses include, but are not limited to, alkyl cellulose (e.g., methyl cellulose, ethyl cellulose, ethyl methyl cellulose), hydroxylalkyl cellulose (e.g., hydroxymethyl cellulose, hydroxyethyl cellulose, hydroxypropyl cellulose, hydroxypropyl methyl cellulose, hdyroxyethyl methyl cellulose, and hydroxyethyl ethyl cellulose), and carboxylalkyl cellulose (e.g., carboxymethyl cellulose).

In these embodiments, the first phase can contain up to 50 weight percent polysaccharide based on a total weight of the first phase. For example, the first phase can contain up to 40 weight percent, up to 30 weight percent, up to 25 weight percent, up to 20 weight percent, up to 15 weight percent, or up to 10 weight percent polysaccharide. The first phase typically includes at least 5 weight percent, at least 10 weight percent, or at least 15 weight percent polysaccharide. In some embodiments, the first phase contains 5 to 50 weight percent, 5 to 40 weight percent, 10 to 40 weight percent, 5 to 30 weight percent, 10 to 30 weight percent, 5 to 25 weight percent, 10 to 25 weight percent, or 15 to 25 weight percent polysaccharide based on a total weight of the first phase. The remainder of the first phase (i.e., the part of the first phase that is not a polysaccharide) is typically water or predominately water.

In some examples, the first phase contains 5 to 50 weight percent polysaccharide and 50 to 95 weight percent water, 5 to 40 weight percent polysaccharide and 60 to 95 weight percent water, 10 to 40 weight percent polysaccharide and 60 to 90 weight percent water, 5 to 30 weight percent polysaccharide and 70 to 90 weight percent water, 10 to 30 weight percent polysaccharide and 70 to 90 weight percent water, 5 to 25 weight percent polysaccharide and 75 to 95 weight percent water, 10 to 25 weight percent polysaccharide and 75 to 90 weight percent water, or 15 to 25 weight percent polysaccharide and 75 to 85 weight percent water. The percent weights are based on a total weight of the first phase. In many examples, the first phase includes only water and the dissolved polysaccharide. In other examples, the only other material included in the first phase is an optional organic solvent.

If an optional organic solvent is used in the water/polysaccharide first phase, the organic solvent is selected to be miscible with water. Suitable organic solvents include, for example, an alcohol (e.g., methanol, ethanol, n-propanol, or isopropanol) or a polyol such as compound of Formula (I). The amounts of the optional organic solvent is usually no greater than 10 weight percent, no greater than 5 weight percent, or no greater than 1 weight percent based on the total weight of the first phase. In some examples, the first phase is free or substantially free of the optional organic solvent. As used herein with reference to the optional organic solvent in the first phase, the term “substantially free” means that an organic solvent is not purposely added to the first phase but may be present as an impurity in one of the other components in the first phase. For example, the amount of the optional organic solvent is less than 1 weight percent, less than 0.5 weight percent, or less than 0.1 weight percent based on a total weight of the first phase.

In other embodiments, the first phase contains a mixture of the compound of Formula (I) and a surfactant rather than a mixture of water and dissolved polysaccharide. For at least some second phase compositions, polymeric core particles having greater porosity (e.g., greater pore volume) can be obtained using a first phase that contains the compound of Formula (I) and a surfactant.

Suitable compounds of Formula (I) typically have a value of n that is in a range of 1 to 20, in a range of 1 to 16, in a range of 1 to 12, in a range of 1 to 10, in a range of 1 to 6, or in a range of 1 to 4. In many embodiments, the compound of Formula (I) is glycerol where the variable n is equal to 1. Other example compounds of Formula (I) are diglycerol (n is equal to 2), polyglycerol-3 (n is equal to 3), polyglycerol-4 (n is equal to 4), or polyglycerol-6 (n is equal to 6). The polyglycerols, which can be referred to as polyglycerins, are often a mixture of materials with varying molecular weight (i.e., materials with different values for n). Polyglycerols, diglycerol, and glycerol are commercially available, for example, from Solvay Chemical (Brussels, Belgium) and Wilshire Technologies (Princeton, N.J., USA).

A surfactant is typically used in combination with the compound of Formula (I) in the first phase. The surfactant is often a nonionic surfactant. The nonionic surfactant usually increases the porosity on the surface of the final polymeric particles. The first phase is often free or substantially free of an ionic surfactant that could interfere with the polymerization reaction of the monomers within the second phase. As used herein with reference to the ionic (i.e., anionic or cationic) surfactant, the term “substantially free” means that no ionic surfactant is purposefully added to the first phase but may be present as a trace impurity in one of the other components in the first phase. Any impurity is typically present in an amount no greater than 0.5 weight percent, no greater than 0.1 weight percent, or no greater than 0.05 weight percent based on a total weight of the first phase.

Any suitable nonionic surfactant can be used in the first phase. The nonionic surfactant often has one or more hydroxyl groups or ether linkages (e.g., —CH₂—O—CH₂—) in one portion of the molecule that can hydrogen bond with other components of the reaction mixture. Suitable nonionic surfactants include, but are not limited to alkyl glucosides, alkyl glucamides, alkyl polyglucosides, polyethylene glycol alkyl ethers, block copolymers of polyethylene glycol and polypropylene glycol, and polysorbates. Examples of suitable alkyl glucosides include, but are not limited to, octyl glucoside (also referred to as octyl-beta-D-glucopyranoside) and decyl glucoside (also referred to as decyl-beta-D-glucopyranoside). Examples of suitable alkyl glucamides include, but are not limited to, octanoyl-N-methylglucamide, nonanoyl-N-methylglucamide, and decanoyl-N-methylglucamide. These surfactants can be obtained, for example, from Sigma Aldrich (St. Louis, Mo., USA) or Spectrum Chemicals (New Brunswick, N.J., USA). Examples of suitable alkyl polyglucosides include, but are not limited to, those commercially available from Cognis Corporation (Cincinnati, Ohio, USA) under the trade designation APG (e.g., APG 325) and those commercially available from Dow Chemical (Midland, Mich., USA) under the trade designation TRITON (e.g., TRITON BG-10 and TRITON CG-110). Examples of polyethylene glycol alkyl ethers include, but are not limited to, those commercially available under the trade designation BRIJ (e.g., BRIJ 58 and BRIJ 98) from Sigma Aldrich (St. Louis, Mo., USA). Examples of block copolymers of polyethylene glycol and polypropylene glycol include, but are not limited to, those commercially available under the trade designation PLURONIC from BASF (Florham Park, N.J., USA). Examples of polysorbates include, but are not limited, to those commercially available under the trade designation TWEEN from ICI American, Inc. (Wilmington, Del., USA).

When the first phase contains a mixture of the compound of Formula (I) and a surfactant, the surfactant can be present in any suitable amount. Often, the surfactant is present in an amount equal to at least 0.5 weight percent, at least 1 weight percent, or at least 2 weight percent based on a total weight of the first phase. The surfactant can be present in an amount up to 15 weight percent, up to 12 weight percent, or up to 10 weight percent based on a total weight of the first phase. For example, the surfactant is often present in the first phase in an amount in a range of 0.5 to 15 weight percent, in a range of 1 to 12 weight percent, in a range of 0.5 to 10 weight percent, or in a range of 1 to 10 weight percent based on the total weight of the first phase. The remainder of the first phase (the part of the first phase that is not surfactant) typically is a compound of Formula (I) or predominately the compound of Formula (I).

In some examples, the first phase can contain 0.5 to 15 weight percent surfactant and 85 to 99.5 weight percent compound of Formula (I), 1 to 12 weight percent surfactant and 88 to 99 weight percent compound of Formula (I), 0.5 to 10 weight percent surfactant and 90 to 99.5 weight percent compound of Formula (I), or 1 to 10 weight percent surfactant and 90 to 99 weight percent compound of Formula (I). The percent weights are based on a total weight of the first phase. In many examples, the first phase contains only the surfactant and the compound of Formula (I). In other examples, the only other material included in the first phase is optional organic solvent or optional water.

When the first phase contains the compound of Formula (I) and a surfactant, an optional organic solvent that is miscible with the compound of Formula (I) can be present in the reaction mixture. Suitable organic solvents include, for example, an alcohol such as methanol, ethanol, n-propanol, or isopropanol. Additionally, optional water can be added to the first phase. The amount of any optional water or organic solvent is selected so that the desired viscosity of the first phase can be achieved. The amounts of the optional water or organic solvent is usually no greater than 10 weight percent, no greater than 5 weight percent, or no greater than 1 weight percent based on the total weight of the first phase. If higher amounts of water are included, the porosity may decrease. In some embodiments, the first phase is free or substantially free of the optional water or organic solvent. As used herein with reference to the optional water or organic solvent in the first phase, the term “substantially free” means that water or organic solvent is not purposely added to the first phase but may be present as an impurity in one of the other components in the first phase. For example, the amount of the optional water or organic solvent is less than 1 weight percent, less than 0.5 weight percent, or less than 0.1 weight percent based on a total weight of the first phase.

The reaction mixture includes a second phase dispersed in the first phase. The volume of the first phase is greater than the volume of the second phase. The volume of the first phase is sufficiently large compared to the volume of the second phase so that the second phase can be dispersed in the form of droplets within the first phase. Within each droplet, the monomer composition is polymerized to form a polymerized product. To form polymeric particles from the second phase, the volume ratio of the first phase to the second phase is typically at least 2:1. As the volume ratio increases (e.g., when the ratio is at least 3:1, at least 4:1, or at least 5:1), polymeric particles can be formed that have a relatively uniform size and shape. If the volume ratio is too large, however, the reaction efficiency is diminished (i.e., a smaller amount of polymeric particles are produced). The volume ratio is generally no greater than 25:1, no greater than 20:1, no greater than 15:1, or no greater than 10:1.

The second phase includes both a monomer composition plus a poly(propylene glycol) having a weight average molecular weight of at least 500 grams/mole. The weight average molecular weight is often at least 1000 grams/mole or at least 2000 grams/mole. The weight average molecular weight can be up to 10,000 grams/mole or greater or up to 5,000 grams/mole. In some embodiments, weight average molecular weight is in a range of 500 to 10,000 grams/mole, in a range of 1,000 to 10,000 grams/mole, or in a range of 1,000 to 5,000 grams/mole. The polypropylene glycol functions as a porogen that gets partially entrained within the polymerized product as it is formed from the monomer composition. Because the polypropylene glycol has no polymerizable group, this material can be removed after formation of the polymerized product. Pores (i.e., void volume or free volume) are created when the previously entrained polypropylene glycol is removed. The polymeric core particles resulting from the removal of the entrained polypropylene glycol are porous. In at least some embodiments, these porous polymeric core particles have hollow centers. The presence of pores or the presence of both pores and hollow centers make the polymeric core particles well suited for storage and delivery of various nitrogen-containing curing agents.

The monomer composition within the second phase contains a first monomer of Formula (II)

CH₂═C(R¹)—(CO)—O[—CH₂—CH₂—O]ₚ—(CO)—C(R¹)═CH₂ (II)

where the variable p is an integer equal to at least 1. In some embodiments, the variable p is an integer no greater than 30, no greater than 20, no greater than 16, no greater than 12, or no greater than 10. The number average molecular weight of the ethylene oxide portion of the monomer (i.e., the group —[CH₂CH₂—O]ₚ—) is often no greater than 1200 grams/mole (Daltons), no greater 1000 grams/mole, no greater than 800 grams/mole, no greater than 600 grams/mole, no greater than 400 grams/mole, no greater than 200 grams/mole, or no greater than 100 grams/mole. The group R¹ is hydrogen or methyl. The monomer of Formula (II) in the second phase is typically not miscible with the first phase.

Suitable first monomers of Formula (II) are commercially available from Sartomer (Exton, Pa., USA) under the trade designation SR206 for ethylene glycol dimethacrylate, SR231 for diethylene glycol dimethacrylate, SR205 for triethylene glycol dimethacrylate, SR206 for tetraethylene glycol dimethacrylate, SR210 and SR210A for polyethylene glycol dimethacrylate, SR259 for polyethylene glycol (200) diacrylate, SR603 (e.g., SR6030P) and SR344 for polyethylene glycol (400) di(meth)acrylate, SR252 and SR610 for polyethylene glycol (600) di(meth)acrylate, and SR740 for polyethylene glycol (1000) dimethacrylate.

In some embodiments, the first monomer of Formula (II) is the only monomer in the monomer composition of the second phase. In other embodiments, the first monomer of Formula (II) can be used in combination with at least one second monomer. The second monomer has a single ethylenically unsaturated group, which is often a (meth)acryloyl group of formula H₂C═CR¹—(CO)— where R¹ is hydrogen or methyl. Suitable second monomers usually are not miscible with the first phase but can be either miscible or not miscible with the first monomer of Formula (II).

Some example second monomers are of Formula (III).

CH₂═CR¹—(CO)—O—Y—R² (III)

In this formula, group R¹ is hydrogen or methyl. In many embodiments, R¹ is hydrogen. Group Y is a single bond, alkylene, oxyalkylene, or poly(oxyalkylene). Group R² is a carbocyclic group or heterocyclic group. These second monomers tend to be miscible with the first monomer of Formula (I) in the second phase but are not miscible with the first phase.

As used herein, the term “alkylene” refers to a divalent group that is a radical of an alkane and includes groups that are linear, branched, cyclic, bicyclic, or a combination thereof. As used herein, the term “oxyalkylene” refers to a divalent group that is an oxy group bonded directly to an alkylene group. As used herein, the term “poly(oxyalkylene)” refers to a divalent group having multiple oxyalkylene units. Suitable Y alkylene and oxyalkylene groups typically have 1 to 20 carbon atoms, 1 to 16 carbon atoms, 1 to 12 carbon atoms, 1 to 10 carbon atoms, 1 to 8 carbon atoms, 1 to 6 carbon atoms, or 1 to 3 carbon atoms. The oxyalkylene is often oxyethylene or oxypropylene. Suitable poly(oxyalkylene) groups typically have 2 to 20 carbon atoms, 2 to 16 carbon atoms, 2 to 12 carbon atoms, 2 to 10 carbon atoms, 2 to 8 carbon atoms, 2 to 6 carbon atoms, or 2 to 4 carbon atoms. The poly(oxyalkylene) is often poly(oxyethylene), which can be referred to as poly(ethylene oxide) or poly(ethylene glycol).

Carbocyclic R² groups can have a single ring or can have multiple rings such as fused rings or bicyclic rings. Each ring can be saturated, partially unsaturated, or unsaturated. Each ring carbon atom can be unsubstituted or substituted with alkyl groups. Carbocyclic groups often have 5 to 12 carbon atoms, 5 to 10 carbon atoms, or 6 to 10 carbon atoms. Examples of carbocyclic groups include, but are not limited to, phenyl, cyclohexyl, cyclopentyl, isobornyl, and the like. Any of these carbocyclic groups can be substituted with an alkyl group having 1 to 20 carbon atoms, 1 to 10 carbon atoms, 1 to 6 carbon atoms, or 1 to 4 carbon atoms.

Heterocyclic R² groups can have a single ring or multiple rings such as fused rings or bicyclic rings. Each ring can be saturated, partially unsaturated, or unsaturated. The heterocyclic group contains at least one heteroatom selected from oxygen, nitrogen, or sulfur. The heterocyclic group often has 3 to 10 carbon atoms and 1 to 3 heteroatoms, 3 to 6 carbon atoms and 1 to 2 heteroatoms, or 3 to 5 carbon atoms and 1 to 2 heteroatoms. Examples of heterocyclic rings include, but are not limited to, tetrahydrofurfuryl.

Exemplary monomers of Formula (III) for use as the second monomer include, but are not limited to, benzyl (meth)acrylate, 2-phenoxyethyl (meth)acrylate (commercially available from Sartomer under the trade designation SR339 and SR340), isobornyl (meth)acrylate, tetrahydrofurfuryl (meth)acrylate (commercially available from Sartomer under the trade designation SR285 and SR203), 3,3,5-trimethylcyclohexyl (meth)acrylate (commercially available from Sartomer under the trade designation CD421 and CD421A), and ethoxylated nonyl phenol acrylate (commercially available from Sartomer under then trade designation SR504, CD613, and CD612).

Other example second monomers are alkyl (meth)acrylates of Formula (IV).

CH₂═CR¹—(CO)—O—R³ (IV)

In Formula (IV), group R¹ is hydrogen or methyl. In many embodiments, R¹ is hydrogen. Group R³ is a linear or branched alkyl having 1 to 20 carbon atoms, 1 to 10 carbon atoms, 1 to 6 carbon atoms, or 1 to 4 carbon atoms. These second monomers tend to be miscible with the first monomer of Formula (I) in the second phase but are not miscible with the first phase.

Examples of alkyl (meth)acrylates of Formula (IV) include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, n-pentyl (meth)acrylate, 2-methylbutyl (meth)acrylate, n-hexyl (meth)acrylate, 4-methyl-2-pentyl (meth)acrylate, 2-ethylhexyl (meth)acrylate, 2-methylhexyl (meth)acrylate, n-octyl (meth)acrylate, isooctyl (meth)acrylate, 2-octyl (meth)acrylate, isononyl (meth)acrylate, isoamyl (meth)acrylate, n-decyl (meth)acrylate, isodecyl (meth)acrylate, 2-propylheptyl (meth)acrylate, isotridecyl (meth)acrylate, isostearyl (meth)acrylate, octadecyl (meth)acrylate, 2-octyldecyl (meth)acrylate, dodecyl (meth)acrylate, lauryl (meth)acrylate, and heptadecanyl (meth)acrylate.

In some embodiments, the only monomers in the monomer composition are the first monomer of Formula (II) and the second monomer of Formula (III), Formula (IV), or both. Any suitable amounts of the first monomer and second monomer can be used. The monomer composition often contains 10 to 90 weight percent of the first monomer and 10 to 90 weight percent of the second monomer based on a total weight of monomers in the monomer composition. For example, the second phase can contain 20 to 80 weight percent of the first monomer and 20 to 80 weight percent of the second monomer, 25 to 75 weight percent of the first monomer and 25 to 75 weight percent of the second monomer, 30 to 70 weight percent of the first monomer and 30 to 70 weight percent of the second monomer, or 40 to 60 weight percent of the first monomer and 40 to 60 weight percent of the second monomer based on a total weight of monomers in the monomer composition.

Depending on the particular nitrogen-containing curing agent that will be positioned within the polymeric core particle, it can be desirable to include at least one hydrophilic second monomer in the monomer composition. The addition of a hydrophilic second monomer tends to make the polymeric core particles more suitable for storage and delivery of hydrophilic nitrogen-containing curing agents. Hydrophilic second monomers are selected so that they are not miscible with the first phase. These monomers may or may not be miscible with the first monomer of Formula (II).

Some example hydrophilic second monomers are hydroxyl-containing monomers of Formula (V).

CH₂═CR¹—(CO)—O—R⁴ (V)

In Formula (V), group R¹ is hydrogen or methyl. In many embodiments, R¹ is hydrogen. Group R⁴ is an alkyl substituted with one or more hydroxyl groups or a group of formula —(CH₂CH₂O)_{q}CH₂CH₂OH where q is an integer equal to at least 1. The alkyl group typically has 1 to 10 carbon atoms, 1 to 6 carbon atoms, 1 to 4 carbon atoms, or 1 to 3 carbon atoms. The number of hydroxyl groups is often in a range of 1 to 3. The variable q is often in a range of 1 to 20, in a range of 1 to 15, in a range of 1 to 10, or in a range of 1 to 5. In many embodiments, the second monomer of Formula (IV) has a single hydroxyl group.

Example monomers of Formula (V) include, but are not limited to, 2-hydroxyethyl (meth)acrylate, 2-hydroxypropyl (meth)acrylate, 3-hydroxypropyl (meth)acrylate, and 4-hydroxybutyl (meth)acrylate, 2-hydroxylbutyl (meth)acrylate, polyethylene glycol mono(meth)acrylate (e.g., monomers commercially available from Sartomer (Exton, PA, USA) under the trade designation CD570, CD571, and CD572), and glycol mono(meth)acrylate.

Other example hydrophilic second monomers are hydroxyl-containing monomers of Formula (VI).

CH₂═CR¹—(CO)—O—R⁵O—Ar (VI)

In Formula (VI), group R¹ is hydrogen or methyl. In many embodiments, R¹ is hydrogen. Groups R⁵ is an alkylene substituted with at least one hydroxyl group. Suitable alkylene groups often have 1 to 10 carbon atoms, 1 to 6 carbon atoms, or 1 to 4 carbon atoms. The alkylene group R⁵ can be substituted with 1 to 3 hydroxyl groups but is often substituted with a single hydroxyl group. The group Ar is an aryl group having 6 to 10 carbon atoms. In many embodiments, the Ar group is phenyl. One example monomer of Formula (VI) is 2-hydroxy-2-phenoxypropyl (meth)acrylate.

If the second monomer is of Formula (V) or (VI), which are hydroxyl-containing monomers, the amount of this monomer that can be combined with the first monomer of Formula (II) is often no greater than 2 weight percent based on a total weight of monomers in the monomer composition. If greater than about 2 weight percent of the second monomer of Formula (V) or (VI) is used, the resulting polymeric particles tend to have diminished porosity.

Other hydrophilic monomers can be used as the second monomers in larger quantities than the second monomers of Formula (V) or (VI) without diminishing the porosity of the resulting polymeric core particles. For example, sulfonyl-containing monomers of Formula (VII) or a salt thereof can be included in the monomer composition along with the first monomer of Formula (II).

CH₂═CR¹—(CO)—O—R⁶—SO₃H (VII)

In Formula (VII), group R¹ is hydrogen or methyl. In many embodiments, R¹ is hydrogen. Group R⁶ is an alkylene having 1 to 10 carbon atoms, 1 to 6 carbon atoms, or 1 to 4 carbon atoms. Examples of sulfonyl-containing monomers of Formula (VII) include, but are not limited to, sulfoethyl (meth)acrylate (e.g., 2-sulfoethyl methacrylate) and sulfopropyl (meth)acrylate. The sulfonyl-containing monomers can be salts under some pH conditions. That is, this monomer can have a negative charge and be associated with a positively charged counter ion. Example counter ions include, but are not limited to, alkali metals, alkaline earth metals, ammonium ions, and tetraalkyl ammonium ions.

If the second monomer is a sulfonyl-containing monomer of Formula (VII), the monomer composition can contain up to 20 weight percent of this monomer based on a total weight of monomers in the monomer composition. In some embodiments, the only monomers in the monomer composition are the first monomer of Formula (II) and the second monomer of Formula (VII). Any suitable amounts of the first monomer and second monomer can be used. The monomer composition often contains 80 to 99 weight percent of the first monomer of Formula (II) and 1 to 20 weight percent of the second monomer of Formula (VII) based on a total weight of monomers in the monomer composition. For example, the monomer composition can contain 85 to 99 weight percent of the first monomer and 1 to 15 weight percent of the second monomer, 90 to 99 weight percent of the first monomer and 1 to 10 weight percent of the second monomer, and 95 to 99 weight percent of the first monomer and 1 to 5 weight percent of the second monomer based on a total weight of monomers in the monomer composition.

In other embodiments, the monomer composition includes a first monomer of Formula (II) and two second monomers, which are a sulfonyl-containing monomer, such as those of Formula (VII), and a hydroxyl-containing monomer, such as those of Formula (V) or (VI). When the hydroxyl-containing monomer is combined with a sulfonyl-containing monomer, higher amounts of the hydroxyl-containing monomer can be added to the monomer composition without substantially decreasing the porosity of the resulting polymeric particles. That is, the amount of the hydroxyl-containing monomer can be greater than 2 weight percent based on the weight of the monomers in the monomer composition. Such monomer compositions often contain 80 to 99 weight percent of the first monomer of Formula (II) and 1 to 20 weight percent of the second monomer, wherein the second monomer is a mixture of the sulfonyl-containing monomer and the hydroxyl-containing monomer. Up to 50 weight percent, up to 40 weight percent, up to 20 weight percent, or up to 10 weight percent of the second monomer can be the hydroxyl-containing monomer.

In still other embodiments, the monomer composition includes a first monomer of Formula (II) and two second monomers, which are a sulfonyl-containing monomer, such as those of Formula (VII), and a monomer of Formula (III). Such monomer compositions often contain 1 to 20 weight percent of the monomer of Formula (VII) and 80 to 99 weight percent of a mixture of the monomer of Formula (II) and the monomer of Formula (III). For example, the monomer compositions can contain 1 to 10 weight percent of the monomer of Formula (VII) and 90 to 99 weight percent of a mixture of the monomer of Formula (II) and the monomer of Formula (III) or can contain 1 to 5 weight percent of the monomer of Formula (VII) and 95 to 99 weight percent of a mixture of the monomer of Formula (II) and the monomer of Formula (III). These compositions can be advantageous because they can be used to load either hydrophobic or hydrophilic nitrogen-containing curing agents.

In some more specific examples, the monomer composition can contain 1 to 20 weight percent of the monomer of Formula (VII), 1 to 98 weight percent of the monomer of Formula (II), and 1 to 98 weight percent of the monomer of Formula (III). In another example, the monomer composition can contain 1 to 20 weight percent of the monomer of Formula (VII), 5 to 95 weight percent of the monomer of Formula (II), and 5 to 95 weight percent of the monomer of Formula (III). In another example, the monomer composition contains 1 to 10 weight percent of the monomer of Formula (VII), 20 to 80 weight percent of the monomer of Formula (II), and 20 to 80 weight percent of the monomer of Formula (III). In yet another example, the monomer composition contains 1 to 10 weight percent of the monomer of Formula (VII), 30 to 70 weight percent of the monomer of Formula (II), and 30 to 70 weight percent of the monomer of Formula (III). In still another example, the monomer composition contains 1 to 10 weight percent of the monomer of Formula (VII), 40 to 60 weight percent of the monomer of Formula (II), and 40 to 60 weight percent of the monomer of Formula (III).

In these monomer compositions containing the monomers of Formulas (VII), (II), and (III), the amount of the monomer of Formula (VII) can be used to control the average size of the porous polymeric core particle. For example, when about 5 weight percent of the monomer of Formula (VII) is included in the monomer composition, the resulting porous polymeric core particles have an average diameter of approximately 10 micrometers. When about 1 weight percent of the monomer of Formula (VII) is included in the monomer composition, the resulting porous polymeric core particles have an average diameter of approximately 3 micrometers.

Still other example second monomers are carboxyl-containing monomers that have a carboxylic acid group (—COOH) or salt thereof. Examples of these carboxyl-containing monomers include, but are not limited to, (meth)acrylic acid and carboxyalkyl (meth)acrylates such as 2-carboxyethyl (meth)acrylate, 3-carboxypropyl (meth)acrylate, and the like. The carboxyl-containing monomers can be salts under some pH conditions. That is, these monomer can have a negative charge and be associated with a positively charged counter ion. Example counter ions include, but are not limited to, alkali metals, alkaline earth metals, ammonium ions, and tetraalkyl ammonium ions.

Yet other second monomers are quaternary ammonium salts such as, for example, (meth)acrylamidoalkyltrimethylammonium salts (e.g., 3-methacrylamidopropyltrimethylammonium chloride and 3-acrylamidopropyltrimethylammonium chloride) and (meth)acryloxyalkyltrimethylammonium salts (e.g., 2-acryloxyethyltrimethylammonium chloride, 2-methacryloxyethyltrimethylammonium chloride, 3-methacryloxy-2-hydroxypropyltrimethylammonium chloride, 3-acryloxy-2-hydroxypropyltrimethylammonium chloride, and 2-acryloxyethyltrimethylammonium methyl sulfate).

In addition to the first monomer of Formula (II) or to a mixture of the first monomer of Formula (II) and one or more of the second monomers described above, the monomer composition can optionally contain a third monomer with at least two polymerizable groups. The polymerizable groups are typically (meth)acryloyl groups. In many embodiments, the third monomer has two or three (meth)acryloyl groups. The third monomer typically is not miscible with the first phase and may or may not be miscible with the first monomer of Formula (II).

Some third monomers have a hydroxyl group. Such monomers can function as crosslinkers like the first monomer of Formula (II) but can provide polymeric particles with increased hydrophilic character. This can be desirable for the storage and delivery of hydrophilic nitrogen-containing curing agents. An example hydroxyl-containing third monomer is glycerol di(meth)acrylate.

Some third monomers are selected to have at least three polymerizable groups. Such third monomers can be added to provide more rigidity to the resulting polymeric particles. The addition of these third monomers tends to minimize swelling of the polymeric particles when exposed to an active agent or when exposed to moisture. Suitable third monomers include, but are not limited to, ethoxylated trimethylolpropane tri(meth)acrylates such as ethoxylated (15) trimethylolpropane triacrylate (commercially available under the trade designation SR9035 from Sartomer) and ethoxylated (20) trimethylolpropane triacrylate (commercially available under the trade designation SR415 from Sartomer); propoxylated trimethylolpropane tri(meth)acrylates such as propoxylated (3) trimethylolpropane triacrylate (commercially available under the trade designation SR492 from Sartomer) and propoxylated (6) trimethylolpropane triacrylate (commercially available under the trade designation CD501 from Sartomer); tris(2-hydroxyethyl) isocyanurate tri(meth)acrylates such as tris(2-hydroxyethyl) isocyanurate triacrylate (commercially available under the trade designations SR368 and SR368D from Sartomer); and propoxylated glyceryl tri(meth)acrylates such as propoxylated (3) glycerol triacrylate (commercially available under the trade designation SR9020 and SR9020HP from Sartomer).

When a third monomer is present in the monomer composition, any suitable amount can be used. The third monomer is often used in an amount up to 20 weight percent based on the total weight of monomers in the monomer composition. In some embodiments, the amount of the third monomer is up to 15 weight percent, up to 10 weight percent, or up to 5 weight percent.

The monomer composition often contains 10 to 100 weight percent of the first monomer, 0 to 90 weight percent of the second monomer, and 0 to 20 weight percent of the third monomer based on a total weight of monomers in the monomer composition. For example, the monomer composition can contain 10 to 90 weight percent of the first monomer, 10 to 90 weight percent of the second monomer, and 0 to 20 weight percent of the third monomer. The monomer composition can contain 10 to 89 weight percent of the first monomer, 10 to 89 weight percent of the second monomer, and 1 to 20 weight percent of the third monomer based on a total weight of the monomer composition.

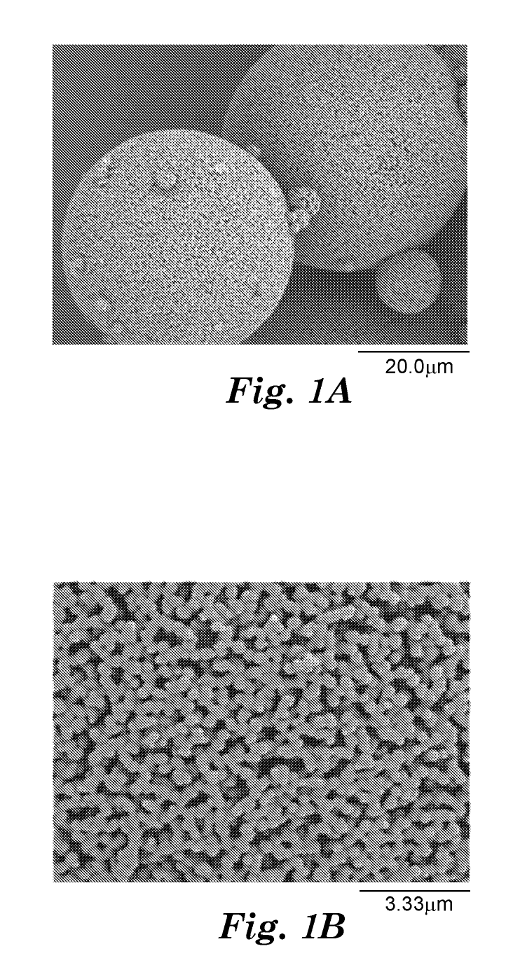

In addition to the monomer composition, the second phase contains poly(propylene glycol), which functions as a porogen. The poly(propylene glycol) is soluble in the monomer composition within the second phase but is dispersible within the first phase. Stated differently, the poly(propylene glycol) is completely miscible with the second phase and partially miscible with the first phase. The poly(propylene glycol) is removed after polymerization of the monomer composition to provide pores (e.g., void volumes or free volumes) in the polymeric core particle. The poly(propylene glycol) does not have any polymerizable groups (i.e., it is not a monomer) and, in general, is not covalently attached to the polymeric core particles that form within the second phase. It is believed that some of the poly(propylene glycol) may become entrained within the polymerized product. The removal of the entrained poly(propylene glycol) can result in the formation of hollow polymeric core particles. It is further believed that some of the poly(propylene glycol) may be positioned on the interface between the first phase and the second phase as the polymerized product is formed in the second phase. The presence of the poly(propylene glycol) at the surface of the forming polymerized product may result in the formation of a polymeric particles having surface porosity. The surface porosity can be seen from electron micrographs of the polymeric particles such as in FIGS. 1A and 1B.

Any suitable molecular weight of poly(propylene glycol) can be used as the porogen. The molecular weight can affect the size of the pores that are formed in the polymeric core particles. That is, the pore size tends to increase with the molecular weight of the poly(propylene glycol). The weight average molecular weight is often at least 500 grams/mole, at least 800 grams/mole, or at least 1000 grams/mole. The weight average molecular weight of the poly(propylene glycol) can be up to 10,000 gram/mole or greater. For ease of use, a poly(propylene glycol) that is a liquid at room temperature is often selected. Poly(propylene glycol) having a weight average molecular weight up to about 4000 g/mole or 5000 grams/mole tends to be a liquid at room temperature. Poly(propylene glycol) that is not a liquid at room temperature can be used if it is initially dissolved in a suitable organic solvent such as an alcohol (e.g., ethanol, n-propanol, or isopropanol). The weight average molecular weight of the poly(propylene glycol) is often in a range of 500 to 10,000 grams/mole, in a range of 1000 to 10,000 grams/mole, in a range of 1000 to 8000 grams/mole, in a range of 1000 to 5000 grams/mole, in a range of 1000 to 4000 grams/mole.

The second phase can contain up to 50 weight percent poly(propylene glycol). If higher amounts of the poly(propylene glycol) are used, there may be an insufficient amount of the monomer composition included in the second phase to form polymeric core particles that are uniformly shaped. In many embodiments, the second phase can contain up to 45 weight percent, up to 40 weight percent, up to 35 weight percent, up to 30 weight percent, or up to 25 weight percent poly(propylene glycol) based on a total weight of the second phase. The second phase typically contains at least 5 weight percent poly(propylene glycol). If lower amounts of the poly(propylene glycol) are used, the porosity of the resulting polymeric particles may be insufficient. That is, the void volume of the polymeric core particles may be insufficient to load and deliver an effective amount of a nitrogen-containing curing agent. The second phase typically can contain at least 10 weight percent, at least 15 weight percent, or at least 20 weight percent poly(propylene glycol). In some embodiments, the second phase contains 5 to 50 weight percent, 10 to 50 weight percent, 10 to 40 weight percent, 10 to 30 weight percent, 20 to 50 weight percent, 20 to 40 weight percent, or 25 to 35 weight percent poly(propylene glycol) based on the total weight of the second phase.

In some embodiments, the second phase contains 50 to 90 weight percent monomer composition and 10 to 50 weight percent poly(propylene glycol), 60 to 90 weight percent monomer composition and 10 to 40 weight percent poly(propylene glycol), 50 to 80 weight percent monomer composition and 20 to 50 weight percent poly(propylene glycol), or 60 to 80 weight percent monomer composition and 20 to 40 weight percent poly(propylene glycol) based on a total weight of the second phase.

In addition to the monomer composition and poly(propylene glycol), the second phase often contains an initiator for free radical polymerization of the monomer composition. Any suitable initiator known in the art can be used. The initiator can be a thermal initiator, a photoinitiator, or both. The specific initiator used is often selected based on its solubility in the second phase. The initiator is often used at a concentration of 0.1 to 5 weight percent, 0.1 to 3 weight percent, 0.1 to 2 weight percent, or 0.1 to 1 weight percent based on the weight of monomers in the monomer composition.

When a thermal initiator is added to the reaction mixture, polymeric particles can be formed at room temperature (i.e., 20° C. to 25° C.) or at an elevated temperature. The temperature needed for polymerization often depends on the particular thermal initiator used. Examples of thermal initiators include organic peroxides and azo compounds.

When a photoinitiator is added to the reaction mixture, polymeric particles can be formed by the application of actinic radiation. Suitable actinic radiation includes electromagnetic radiation in the infrared region, visible region, ultraviolet region, or a combination thereof.

Examples of photoinitiators suitable in the ultraviolet region include, but are not limited to, benzoin, benzoin alkyl ethers (e.g., benzoin methyl ether and substituted benzoin alkyl ethers such 4,4′-dimethoxybenzoin), phenones (e.g., substituted acetophenones such as 2,2-dimethoxy-2-phenylacetophenone and substituted alpha-ketols such as 2-methyl-2-hydroxypropiophenone), phosphine oxides, polymeric photoinitiators, and the like.

Commercially available photoinitiators include, but are not limited to, 2-hydroxy-2-methyl-1-phenyl-propane-1-one (e.g., commercially available under the trade designation DAROCUR 1173 from Ciba Specialty Chemicals), a mixture of 2,4,6-trimethylbenzoyl-diphenyl-phosphine oxide and 2-hydroxy-2-methyl-1-phenyl-propan-1-one (e.g., commercially available under the trade designation DAROCUR 4265 from Ciba Specialty Chemicals), 2,2-dimethoxy-1,2-diphenylethan-1-one (e.g., commercially available under the trade designation IRGACURE 651 from Ciba Specialty Chemicals), a mixture of bis(2,6-dimethoxybenzoyl)-2,4,4-trimethyl-pentylphosphine oxide and 1-hydroxy-cyclohexyl-phenyl-ketone (e.g., commercially available under the trade designation IRGACURE 1800 from Ciba Specialty Chemicals), a mixture of bis(2,6-dimethoxybenzoyl)-2,4,4-trimethyl-pentylphosphine oxide (e.g., commercially available under the trade designation IRGACURE 1700 from Ciba Specialty Chemicals), 2-methyl-1[4-(methylthio)phenyl]-2-morpholinopropan-1-one (e.g., commercially available under the trade designation IRGACURE 907 from Ciba Specialty Chemicals), 1-hydroxy-cyclohexyl-phenyl-ketone (e.g., commercially available under the trade designation IRGACURE 184 from Ciba Specialty Chemicals), 2-benzyl-2-(dimethylamino)-1-[4-(4-morpholinyl)phenyl]-1-butanone (e.g., commercially available under the trade designation IRGACURE 369 from Ciba Specialty Chemicals), bis(2,4,6-trimethylbenzoyl)-phenylphosphine oxide (e.g., commercially available under the trade designation IRGACURE 819 from Ciba Specialty Chemicals), ethyl 2,4,6-trimethylbenzoyldiphenyl phosphinate (e.g., commercially available from BASF, Charlotte, N.C. under the trade designation LUCIRIN TPO-L), and 2,4,6-trimethylbenzoyldiphenylphosphine oxide (e.g., commercially available from BASF, Charlotte, N.C. under the trade designation LUCIRIN TPO).

The reaction mixture often includes at least 5 weight percent of the second phase (dispersed phase) and up to 95 weight percent of the first phase (continuous phase). In some embodiments, the reaction mixture contains 5 to 40 weight percent second phase and 60 to 95 weight percent first phase, 5 to 30 weight percent second phase and 70 to 95 weight percent first phase, 10 to 30 weight percent second phase and 70 to 90 weight percent first phase, or 5 to 20 weight percent second phase and 80 to 95 weight percent first phase. The weight percentages are based on a total weight of the reaction mixture.

To prepare the polymeric core particles, droplets of the second phase are formed in the first phase. The components of the second phase are often mixed together prior to addition to the first phase. For example, the monomer composition, initiator, and the poly(propylene glycol) can be blended together and then this blended composition, which is the second phase, can be added to the first phase. The resulting reaction mixture is often mixed under high shear to form a micro-emulsion. The size of the dispersed second phase droplets can be controlled by the amount of shear, the mixing rate, and the composition. The size of the droplets can be determined by placing a sample of the mixture under an optical microscope prior to polymerization. Although any desired droplet size can be used, the average droplet diameter is often less than 200 micrometers, less than 100 micrometers, less than 50 micrometers, less than 25 micrometers, less than 10 micrometers, or less than 5 micrometers. For example, the average droplet diameter can be in the range of 1 to 200 micrometers, 1 to 100 micrometers, 5 to 100 micrometers, 5 to 50 micrometers, 5 to 25 micrometers, or 5 to 10 micrometers.

If a photoinitiator is used, the reaction mixture is often spread on a non-reactive surface to a thickness that can be penetrated by the desired actinic radiation. The reaction mixture is spread using methods that do not cause the droplets to coalesce. For example, the reaction mixture can be formed using an extrusion method. Often, the actinic radiation is in the ultraviolet region of the electromagnetic spectrum. If the ultraviolet radiation is applied from only the top surface of the reaction mixture layer, the thickness of the layer can be up to about 10 millimeters. If the reaction mixture layer is exposed to ultraviolet radiation from both the top and bottom surfaces, the thickness can be greater such as up to about 20 millimeters. The reaction mixture is subjected to the actinic radiation for a time sufficient to react the monomer composition and form polymeric particles. The reaction mixture layer is often polymerized within 5 minutes, within 10 minutes, within 20 minutes, within 30 minutes, within 45 minutes, or within 1 hour depending on the intensity of the actinic radiation source and the thickness of the reaction mixture layer.

If a thermal initiator is used, the droplets can be polymerized while continuing to mix the reaction mixture. Alternatively, the reaction mixture can be spread on a non-reactive surface to any desired thickness. The reaction mixture layer can be heated from the top surface, from the bottom surface, or both to form the polymeric core particles. The thickness is often selected to be comparable to that used with the use of actinic radiation such as ultraviolet radiation.

In many embodiments, a photoinitiator is preferred over a thermal initiator because lower temperatures can be used for polymerization. That is, the use of actinic radiation such as ultraviolet radiation can be used to minimize degradation of various components of the reaction mixture that might be sensitive to temperatures needed for use with thermal initiators. Further, the temperatures typically associated with the use of thermal initiators may undesirably alter the solubility of the various components of the reaction mixture between the first phase and the dispersed second phase.

During the polymerization reaction, the monomer composition reacts within the dispersed second phase droplets suspended in the first phase. As the polymerization progresses, the poly(propylene glycol) included in the second phase gets partially entrained within the polymerized product. Although it is possible that some portion of the poly(propylene glycol) can be covalently attached to the polymeric product through a chain transfer reaction, preferably the poly(propylene glycol) is not bonded to the polymeric product. The polymerized product is in the form of particles. In some embodiments, the particles are polymeric beads having a relatively uniform size and shape.

After formation of the polymerized product (i.e., polymeric particles containing entrained poly(propylene glycol)), the polymerized product can be separated from the first phase. Any suitable separation method can be used. For example, water is often added to lower the viscosity of the first phase. The particle of the polymerized product can be separated by decantation, filtration, or centrifugation. The particles of the polymerized product can be further washed by suspending them in water and collecting them a second time by decantation, filtration, centrifugation, or drying.

The particles of the polymerized product can then be subjected to one or more washing steps to remove the poly(propylene glycol) porogen. Suitable solvents for removing the poly(propylene glycol) include, for example, acetone, methyl ethyl ketone, toluene, and alcohols such as ethanol, n-propanol, or isopropanol. Stated differently, the entrained poly(propylene glycol) is removed from the polymerized product using solvent extraction methods. Pores are created where the poly(propylene glycol) previously resided.

In many embodiments, the resulting porous polymeric core particles (the polymerized product after removal of the poly(propylene glycol) porogen) have an average diameter that is less than 200 micrometers, less than 100 micrometers, less than 50 micrometers, less than 25 micrometers, less than 10 micrometers, or less than 5 micrometers. For example, the porous polymeric core particles can have an average diameter in the range of 1 to 200 micrometers, 1 to 100 micrometers, 5 to 100 micrometers, 5 to 50 micrometers, 5 to 25 micrometers, or 5 to 10 micrometers.

The polymeric core particles usually have multiple pores distributed over the surface of the particles as seen in FIGS. 1A and 1B. Based on the diameter of the particles and the dimensions of the pores, the polymeric core particles can be described as being micro-particles (the average diameter is typically in a range of 1 to 200 micrometers, in the range of 1 to 100 micrometers, or in the range of 1 to 50 micrometers) and nano-porous (the pores have dimensions in an nanometer range such as in the range of 1 to 200 nanometers, in the range of 10 to 200 nanometers, in the range of 20 to 200 nanometers, or in the range of 50 to 200 nanometers). In some embodiments, the polymeric core particles are hollow in addition to having multiple pores distributed over the surface of the particles. As used herein, the term “hollow” refers to polymeric particles that have a polymeric exterior surrounding an inner region (cavity or core) that is not polymeric.

The porous polymeric core particles or the hollow and porous polymeric core particles are well suited for storage and delivery of a nitrogen-containing curing agent. The nitrogen-containing curing agent is positioned or loaded within the porous polymeric core. The nitrogen-containing curing agent is not covalently bonded to the polymeric core in the composite particle. Under suitable conditions, the nitrogen-containing curing agent can be released (i.e., delivered) from the composite particles and reacted with the epoxy resin.

As used herein, the term “nitrogen-containing curing agent” refers to any nitrogen-containing compound that causes the curing of the epoxy resin. The term does not imply or suggest a certain mechanism or reaction for curing. The nitrogen-containing curing agent can directly react with the oxirane ring of the epoxy resin, can catalyze or accelerate the reaction of another nitrogen-containing curing agent with the epoxy resin, or can catalyze or accelerate the self-polymerization of the epoxy resin.

If all of the monomers in the monomer composition are hydrophobic, the polymeric core particles tend to be hydrophobic (i.e., hydrophobic polymeric core particles) and can accept (e.g., be loaded with) hydrophobic nitrogen-containing curing agents. If some of the monomers in the monomer composition are hydrophilic, however, the polymeric core particles tend to have sufficient hydrophilic character (i.e., hydrophilic polymeric core particles) to accept hydrophilic nitrogen-containing curing agents. Further, if the monomer composition includes a mixture of both hydrophobic monomers and hydrophilic monomers, the polymeric core particles tend to have sufficient hydrophobic and hydrophilic character to accept both hydrophobic and hydrophilic nitrogen-containing curing agents. In some embodiments, polymeric core particles having both hydrophobic and hydrophilic character can be desirable.

Some nitrogen-containing curing agents have at least two groups of formula —NR⁷H where R⁷ is selected from hydrogen, alkyl, aryl, or alkylaryl. Suitable alkyl groups often have 1 to 12 carbon atoms, 1 to 8 carbon atoms, 1 to 6 carbon atoms, or 1 to 4 carbon atoms. The alkyl group can be cyclic, branched, linear, or a combination thereof. Suitable aryl groups usually have 6 to 12 carbon atom such as a phenyl or biphenyl group. Suitable alkylaryl groups can be either an alkyl substituted with an aryl or an aryl substituted with an alkyl. The same aryl and alkyl groups discussed above can be used in the alkylaryl groups. When the nitrogen-containing curing agent diffuses from the composite particle into the epoxy resin, the primary and/or secondary amino groups of the curing agent react with the oxirane groups of the epoxy resin. This reaction opens the oxirane groups and covalently bonds the curing agent to the epoxy resin. The reaction results in the formation of divalent groups of formula —OCH₂—CH₂—NR⁷— where R⁷ is equal to hydrogen, alkyl, aryl, or alkylaryl.

The nitrogen-containing curing agent minus the at least two amino groups (i.e., the portion of the curing agent that is not an amino group) can be any suitable aromatic group, aliphatic group, or combination thereof Some amine curing agents are of Formula (VIII) with the additional limitation that there are at least two primary amino groups, at least two secondary amino groups, or at least one primary amino group and at least one secondary amino group.

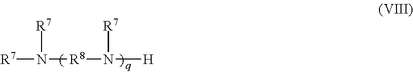

Each R⁷ group is independently hydrogen, alkyl, aryl, or alkylaryl. Suitable alkyl groups for R⁷ often have 1 to 12 carbon atoms, 1 to 8 carbon atoms, 1 to 6 carbon atoms, or 1 to 4 carbon atoms. The alkyl group can be cyclic, branched, linear, or a combination thereof. Suitable aryl groups for R⁷ often have 6 to 12 carbon atoms such as a phenyl or biphenyl group. Suitable alkylaryl groups for R⁷ can be either an alkyl substituted with an aryl or an aryl substituted with an alkyl. The same aryl and alkyl groups discussed above can be used in the alkylaryl groups. Each R⁸ is independently an alkylene, heteroalkylene, or combination thereof. Suitable alkylene groups often have 1 to 18 carbon atoms, 1 to 12 carbon atoms, 1 to 8 carbon atoms, 1 to 6 carbon atoms, or 1 to 4 carbon atoms. Suitable heteroalkylene groups have at least one oxy, thio, or —NH— group positioned between two alkylene groups. Suitable heteroalkylene groups often have 2 to 50 carbon atoms, 2 to 40 carbon atoms, 2 to 30 carbon atoms, 2 to 20 carbon atoms, or 2 to 10 carbon atoms and up to 20 heteroatoms, up to 16 heteroatoms, up to 12 heteroatoms, or up to 10 heteroatoms. The heteroatoms are often oxy groups. The variable q is an integer equal to at least one and can be up to 10 or higher, up to 5, up to 4, or up to 3.

Some amine curing agents can have an R⁸ group selected from an alkylene group. Examples include, but are not limited to, ethylene diamine, diethylene diamine, diethylene triamine, triethylene tetramine, propylene diamine, tetraethylene pentamine, hexaethylene heptamine, hexamethylene diamine, 2-methyl-1,5-pentamethylene diamine, 1-amino-3-aminomethyl-3,3,5-trimethylcyclohexane (also called isophorene diamine), 1,3 bis-aminomethyl cyclohexane, 1,10-dimainodecane, 1,12-diaminododecene, and the like.

Other amine curing agents can have an R³ group selected from a heteroalkylene group such as a heteroalkylene having oxygen heteroatoms. For example, the curing agent can be a compound such as aminoethylpiperazine, 4,7,10-trioxatridecane-1,13-diamine (TTD) available from TCI America in Portland, Oreg., or a poly(alkylene oxide) diamine (also called polyether diamines) such as a poly(ethylene oxide) diamine, poly(propylene oxide) diamine, or a copolymer thereof. Commercially available polyether diamines are commercially available under the trade designation JEFFAMINE from Huntsman Corporation in The Woodlands, Tex.

Still other amine curing agents can be formed by reacting a polyamine (i.e., a polyamine refers to an amine with at least two amino groups selected from primary amino groups and secondary amino groups) with another reactant to form an amine-containing adduct having at least two amino groups. For example, a polyamine can be reacted with an epoxy resin to form an adduct having at least two amino groups. If a polymeric diamine is reacted with a dicarboxylic acid in a molar ratio of diamine to dicarboxylic acid that is greater than or equal to 2:1, a polyamidoamine having two amino groups can be formed. In another example, if a polymeric diamine is reacted with an epoxy resin having two glycidyl groups in a molar ratio of diamine to epoxy resin greater than or equal to 2:1, an amine-containing adduct having two amino groups can be formed. Such a polyamidoamine can be prepared as described, for example, in U.S. Pat. No. 5,629,380 (Baldwin et al.). A molar excess of the polymeric diamine is often used so that the curing agent includes both the amine-containing adduct plus free (non-reacted) polymeric diamine. For example, the molar ratio of diamine to epoxy resin with two glycidyl groups can be greater than 2.5:1, greater than 3:1, greater than 3.5:1, or greater than 4:1. Even when epoxy resin is used to form the amine-containing adduct in the second part of the curable coating composition, additional epoxy resin is present in the first part of the curable coating composition.

The curing agent can also be one or more aromatic rings substituted with multiple amino groups or with amino-containing groups. Such curing agents include, but are not limited to, xylene diamines (e.g., meta-xylene diamine) or similar compounds. For example, one such curing agent is commercially available under the trade designation ANCAMINE (e.g., ANCAMINE 2609) from Air Products and Chemicals, Inc. in Allentown, Pa., USA and under the trade designation ARADUR 2965 from Huntsman Corporation (The Woodlands, Tex., USA). This particular curing agent is based on meta-xylene diamine. Another example curing agent is 4,4′-diaminodiphenyl sulfone (DDS), which is commercially available as ARADUR 9964-1 from Huntsman Corporation.

Still other nitrogen-curing agents are typically considered to be secondary curatives or latent curatives because, compared to curing agents having at least two groups of formula —NHR⁷, they are not as reactive with the oxarine rings of the epoxy resins at room temperature. Often, these curatives are reactive above their melting temperature (e.g., above 150° C., above 170° C., or above 200° C.). Secondary curatives are often imidazoles or salts thereof or imidazolines or salts thereof, substituted ureas (e.g., bis-substituted ureas such as 4,4′-methylene bis(phenyl dimethyl) urea and toluene diisocyanate urea), dicyanamide or derivatives thereof, hydrozides such as aminodihydrazide, adipic dihydrazide, isophthalyl dihydrazide, guanidines such as tetramethyl guanidine, or phenols substituted with tertiary amino groups.

Suitable imidazole compounds include 1-N substituted imidazole, 2-C substituted imidazoles, and metal imidazole salts as described in U.S. Pat. No. 4,948,449 (Tarbutton et al.). Example imidazole compounds are commercially available from Air Products and Chemicals under the trade designation CUREZOL (e.g., CUREZOL 2PZ-S, 2MA-AZINE, and 2MA-OK), under the trade designation ARADUR (ARADUR 3123) from Huntsman Corporation, and from CVC Thermoset Specialties under the trade designation OMICURE (e.g., OMICURE U-35, U-52, and U-52M).

Suitable phenols substituted with tertiary amino groups can be of Formula (IX).

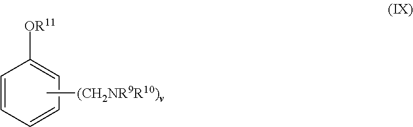

In Formula (IX), each group R⁹ and R¹⁰ is independently an alkyl. The variable v is an integer equal to 2 or 3. Group R¹¹ is hydrogen or alkyl. Suitable alkyl groups for R⁹, R¹⁰, and R¹¹ often have 1 to 12 carbon atoms, 1 to 8 carbon atoms, 1 to 6 carbon atoms, or 1 to 4 carbon atoms. One exemplary secondary curative of Formula (IX) is tris-2,4,6-(dimethylaminomethyl)phenol that is commercially available under the trade designation ANCAMINE K54 from Air Products and Chemicals, Inc. of Allentown, Pa., USA.

Any suitable method can be used to position (i.e., to load) the nitrogen-containing curing agent in the porous polymeric core particle once the porogen has been removed. The nitrogen-containing curing agent is typically positioned within the polymeric core particle prior to formation of the coating polymer layer around the polymeric core particle. In some embodiments, the nitrogen-containing curing agent is a liquid and the polymeric core particles are mixed with the liquid to load the nitrogen-containing curing agent (e.g., to position the nitrogen-containing curing agent within the polymeric core particles). In other embodiments, the nitrogen-containing curing agent can be dissolved in a suitable organic solvent or water and the polymeric core particles are exposed to the resulting solution. Any organic solvent that is used is typically selected so that it does not dissolve the polymeric core particles. When an organic solvent or water is used, at least some of the organic solvent or water may be loaded within the polymeric core particle in addition to the nitrogen-containing curing agent.

When the nitrogen-containing curing agent is dissolved in an organic solvent or water, the concentration is typically selected to be as great as possible to shorten the time needed to load a suitable amount of the nitrogen-containing curing agent within the polymeric core particle. The amount of nitrogen-containing curing agent loaded and the amount of time required for loading (i.e., positioning within the polymeric core particle) are often dependent, for example, on the composition of the monomers used to form the polymeric core particle, the rigidity of the polymeric core particle (e.g., the amount of crosslinking), and the compatibility of the nitrogen-containing curing agent with the polymeric core particle. The loading time is often less than 24 hours, less than 18 hours, less than 12 hours, less than 8 hours, less than 4 hours, less than 2 hours, less than 1 hour, less than 30 minutes, less than 15 minutes, or less than 5 minutes. After loading, the particles are typically separated from the solution containing the nitrogen-containing curing agent by decantation, filtration, centrifugation, drying, or the like.

The volume of nitrogen-containing curing agent loaded can be up to the volume of poly(propylene glycol) removed from the polymerized product used to form the polymeric core particles. That is, the nitrogen-containing curing agent can fill the voids left after removal of the poly(propylene glycol). In many embodiments, the amount of nitrogen-containing curing agent in the composite particle can be up to 70 weight percent, up to 60 weight percent, up to 50 weight percent, or up to 40 weight percent. The amount can be at least 1 weight percent, at least 5 weight percent, at least 10 weight percent, at least 20 weight percent, at least 30 weight percent, at least 40 weight percent, or at least 50 weight percent of the composite particle. For example, the nitrogen-containing curing agent in the composite particle can be in a range of 1 to 70 weight percent, in a range of 1 to 60 weight percent, in a range of 5 to 60 weight percent, in a range of 10 to 60 weight percent, in a range of 20 to 60 weight percent, in a range of 20 to 50 weight percent, in a range of 30 to 50 weight percent, or in a range of 40 to 50 weight percent based on the total weight of the composite particles.

A coating layer is positioned around the porous polymeric core loaded with the nitrogen-containing curing agent (i.e., a coating layer is positioned around the loaded core particle). The coating layer contains a thermoplastic, wax, or mixture thereof. Both thermoplastic polymers and waxes soften when exposed to heat and return to their original forms when cooled to room temperature. The term “thermoplastic” is usually applied to synthetic polymeric materials but can also include naturally occurring polymeric materials having a molecular weight that is greater than most naturally occurring waxes. As used herein, the term “wax” refers to materials that have a lower molecular weight than the polymeric materials that are typically classified as thermoplastics. Waxes usually have at least one long alkyl chain (e.g., 4 to 24 carbon atoms) and are often classified as lipids. Some waxes are hydrocarbons (e.g., paraffin and polyethylene) while many natural waxes are esters of fatty acids and long chain alcohols (e.g., 4 to 24 carbon atoms). Because of the difference in molecular weight, waxes typically have a distinct melting point while thermoplastics have a glass transition temperature.

To be released from the composite core particles and to react with the epoxy resin, the nitrogen-containing curing agent typically diffuses through the coating layer positioned around the loaded polymeric core particle. Diffusion may occur, for example, through an opening within the polymeric matrix of the coating layer, through defects in the coating layer, or by any other mechanism. The thickness and composition of the coating layer as well as the environment surrounding the composite particle can affect the rate of diffusion of the biologically active material out of the loaded polymeric core and through the coating layer.

Depending on the environment and other factors, the release may or may not occur immediately. That is, the onset of release of the nitrogen-containing curing agent may commence immediately or after a certain period of time. Once release commences, however, the amount of the nitrogen-containing curing agent released is usually greatest initially and then decreases over time. Such a release profile can arise when the nitrogen-containing curing agent is more concentrated at the outer edge of the loaded core particle. Such a release profile can also arise when the nitrogen-containing curing agent is distributed uniformly throughout the loaded core polymeric particle because additional time is needed to diffuse from the inner regions of the loaded polymeric core particle.

The coating layer around the polymeric core particle, which in most instances is a loaded polymeric core particle, contains a thermoplastic polymer, a wax, or a mixture thereof. Any suitable thermoplastic polymer and/or wax can be used that allows release of the nitrogen-containing curing agent from the porous polymeric core particle through the coating layer. The thermoplastic polymeric material and/or wax are typically selected to be soluble or dispersible in water, an organic solvent, or a mixture thereof. Neither the thermoplastic polymeric material nor the wax is tacky (i.e., the glass transition temperature is typically at least 20° C.). The thermoplastic polymer is typically selected to be rubbery and not brittle. The thermoplastic polymer is typically a linear polymer and is crosslinked or not crosslinked to such a low amount that it can still be dissolved or dispersed in water, an organic solvent, or a mixture thereof.

The coating layer can be formed by deposition from a coating solution containing the thermoplastic polymer and/or wax. That is, the thermoplastic polymer and/or wax is dissolved in a suitable liquid medium. If the nitrogen-containing curing agent is a non-polar compound (e.g., hydrophobic compound), it is often preferable to use a polar liquid such as water, a polar organic solvent, or a mixture thereof to prepare the coating solution used to form the coating layer; the thermoplastic polymer and/or wax is selected to be soluble in the polar liquid. Conversely, if the nitrogen-containing curing agent is a polar compound (e.g., a hydrophilic compound), it is often preferable to use a non-polar liquid such as a non-polar organic solvent to prepare the coating solution; the thermoplastic polymer can be selected to be soluble in the non-polar organic solvent.

Alternatively, the coating layer can be formed by deposition from a coating dispersion containing the thermoplastic polymer and/or wax. In many embodiments, the thermoplastic polymer and/or wax is dispersed in water. Such water-based dispersions can be used with polar or non-polar nitrogen-containing curing agents. That is, if the dispersions have a sufficiently high weight percent solids content (e.g., greater than 10 weight percent, greater than 20 weight percent, or greater than 25 weight percent, or greater than 30 weight percent), extraction of the nitrogen-containing curing agent from the porous core particle during formation of the composite particle can be minimized regardless of the polarity of the nitrogen-containing curing agent.

The composition of the coating solution or coating dispersion is selected so that a significant amount of the nitrogen-containing curing agent is not extracted out of the loaded polymeric core particle during the deposition of the thermoplastic polymer and/or wax. In some embodiments, the coating solution or coating dispersion extracts less than 10 weight percent, less than 5 weight percent, less than 3 weight percent, less than 2 weight percent, or less than 1 weight percent of the nitrogen-containing curing agent from the loaded polymeric core particle.

In some embodiments, the nitrogen-containing curing agent is a polar compound and the coating solution contains a non-polar organic solvent such as, for example, an alkane (e.g., pentane, hexane, or cyclohexane), benzene, toluene, ketone (e.g., acetone, methyl ethyl ketone, or methyl isobutyl ketone), ether (e.g., diethyl ether or 1,4-dioxane), chloroform, dichloromethane, or the like. The amount of thermoplastic polymer and/or wax in the coating solution depends on its solubility in the non-polar organic solvent, the desired viscosity of the solution, and the desired thickness of the coating layer. In many embodiments, the thermoplastic polymer and/or wax is present in an amount equal to at least 5 weight percent, at least 10 weight percent, or at least 15 weight percent and up to 50 weight percent, up to 40 weight percent, up to 30 weight percent, or up to 20 weight percent based on a total weight of the coating solution.

Suitable thermoplastic polymers for use in the coating solution when the nitrogen-containing curing agent is a polar compound include, but are not limited to, silicone-based thermoplastic polymers, (meth)acrylate-based thermoplastic polymers, olefin-based thermoplastic polymers, and styrene-based thermoplastic polymers.

Suitable silicone-based thermoplastic polymers include those having at least one polydiorganosiloxane unit of formula (—Si(R¹²)₂O—)ₐ where a is an integer equal to at least 3 and R¹² is an alkyl, haloalkyl, alkenyl, aralkyl, aryl, or aryl substituted with an alkyl, alkoxy, or halo. The silicone-based thermoplastic polymers are often a urea-based silicone copolymer, an oxamide-based silicone copolymer, an amide-based silicone copolymer, a urethane-based silicone copolymer, or mixtures thereof. As used herein, the term “urea-based” refers to a segmented copolymer having at least one urea linkage, the term “oxamide-based” refers to a segmented copolymer having at least one oxamide linkage, the term “amide-based” refers to a segmented copolymer having at least one amide linkage, the term “urethane-based” refers to a segmented copolymer having at least one urethane linkage.

These silicone-based thermoplastic polymers are often prepared from a polydiorganosiloxane diamines represented by Formula (X).

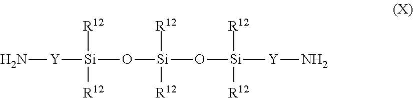

In Formula (X), each R¹² is independently an alkyl, haloalkyl, alkenyl, aralkyl, aryl, or aryl substituted with an alkyl, alkoxy, or halo. Each Y is independently an alkylene, arylene, or aralkylene as defined above for Formula (I). The variable n is an integer of 0 to 1500. For example, subscript n can be an integer up to 1000, up to 500, up to 400, up to 300, up to 200, up to 100, up to 80, or up to 60. The value of n is often at least 40, at least 45, at least 50, or at least 55. For example, subscript n can be in the range of 40 to 1500, 40 to 1000, 40 to 500, 50 to 500, 50 to 400, 50 to 300, 50 to 200, 50 to 100, 50 to 80, or 50 to 60. If any of the polydiorganosiloxane diamine remains in the silicone-based thermoplastic polymers, this material may react with the epoxy resin. Typically, the silicone-based thermoplastic polymers are selected such that they have no greater than 1 weight percent, no greater than 0.5 weight percent, no greater than 0.2 weight percent, no greater than 0.1 weight percent of the polydiorganosiloxane diamine as an impurity.

Suitable alkyl groups for R¹² in Formula (X) typically have 1 to 10 carbon atoms, 1 to 6 carbon atoms, or 1 to 4 carbon atoms. Exemplary alkyl groups include, but are not limited to, methyl, ethyl, isopropyl, n-propyl, n-butyl, and iso-butyl. Suitable haloalkyl groups for le often have only a portion of the hydrogen atoms of the corresponding alkyl group replaced with a halogen. Exemplary haloalkyl groups include chloroalkyl and fluoroalkyl groups with 1 to 3 halo atoms and 3 to 10 carbon atoms. Suitable alkenyl groups for le often have 2 to 10 carbon atoms. Exemplary alkenyl groups often have 2 to 8, 2 to 6, or 2 to 4 carbon atoms. Suitable aryl groups for le often have 6 to 12 carbon atoms. Phenyl is an exemplary aryl group. The aryl group can be unsubstituted or substituted with an alkyl (e.g., an alkyl having 1 to 10 carbon atoms, 1 to 6 carbon atoms, or 1 to 4 carbon atoms), an alkoxy (e.g., an alkoxy having 1 to 10 carbon atoms, 1 to 6 carbon atoms, or 1 to 4 carbon atoms), or halo (e.g., chloro, bromo, or fluoro). Suitable aralkyl groups for le often have an alkyl group having 1 to 10 carbon atoms that is substituted with an aryl group having 6 to 12 carbon atoms. Exemplary aralkyl groups include an alkyl group having 1 to 10 carbon atoms, 1 to 6 carbon atoms, or 1 to 4 carbon atoms that is substituted with a phenyl group.

In many embodiments, at least 50 percent of the R¹² groups are methyl. For example, at least 60 percent, at least 70 percent, at least 80 percent, at least 90 percent, at least 95 percent, at least 98 percent, or at least 99 percent of the R¹² groups can be methyl. The remaining R¹² groups can be selected from an alkyl having at least two carbon atoms, haloalkyl, aralkyl, alkenyl, aryl, or aryl substituted with an alkyl, alkoxy, or halo. For example, all the R⁷ groups can be an alkyl (e.g., methyl or ethyl) or an aryl (e.g., phenyl).

Each Y in Formula (X) is independently an alkylene, an aralkylene, an arylene, or a combination thereof. Exemplary alkylenes, which can be linear or branched and often have 1 to 10 carbon atoms, 1 to 6 carbon atoms, or 1 to 4 carbon atoms. Exemplary arylenes often have 6 to 20 carbon atoms, 6 to 12 carbon atoms, or 6 carbon atoms (i.e., phenylene). Exemplary aralkylenes often have 7 to 20 carbon atoms, 7 to 18 carbon atoms, and 7 to 12 carbon atoms. Aralkylene often include a phenylene group attached to an alkylene having 1 to 12 carbon atoms, 1 to 10 carbon atoms, or 1 to 6 carbon atoms. In many embodiments, Y is an alkylene group.

Specific examples of polydiorganosiloxane diamines include, but are not limited to, polydimethylsiloxane diamine, polydiphenylsiloxane diamine, polytrifluoropropylmethylsiloxane diamine, polyphenylmethylsiloxane diamine, polydiethylsiloxane diamine, polydivinylsiloxane diamine, polyvinylmethylsiloxane diamine, poly(5-hexenyl)methylsiloxane diamine, and mixtures thereof.

The polydiorganosiloxane diamine of Formula (X) can be prepared by any known method and can have any suitable molecular weight, such as a weight average molecular weight in the range of 700 to 150,000 grams per mole (Daltons), in the range of 1,000 to 100,000 grams per mole, in the range of 5,000 to 50,000 grams per mole, or in the range of 10,000 to 40,000 grams per mole, or in the range of 20,000 to 30,000 grams per mole.

Suitable polydiorganosiloxane diamines and methods of making the polydiorganosiloxane diamines are described, for example, in U.S. Pat. No. 3,890,269 (Martin), U.S. Pat. No. 4,661,577 (Lane et al.), U.S. Pat. No. 5,026,890 (Webb et al.), U.S. Pat. No. 5,276,122 (Aoki et al.), U.S. Pat. No. 5,214,119 (Leir et al.), U.S. Pat. No. 5,461,134 (Leir et al.), U.S. Pat. No. 5,512,650 (Leir et al.), and U.S. Pat. No. 6,355,759 (Sherman et al.). Some polydiorganosiloxane diamines are commercially available, for example, from Shin Etsu Silicones of America, Inc. (Torrance, Calif., USA) and from Gelest, Inc. (Morrisville, Pa., USA).

A first example of a useful silicone-based silicone polymer is a silicone polyurea block copolymer. Silicone polyurea block copolymers are the reaction product of a polydiorganosiloxane diamine (also referred to as a silicone diamine) of Formula (X), a polyisocyanate, and an optional organic polyamine. As used herein, the term “polyisocyanate” refers to a compound having more than one isocyanate group. As used herein, the term “polyamine” refers to a compound having more than one amino group (e.g., primary amino group, secondary amino group, or combination thereof). The term “organic polyamine” refers to a polyamine that does not include a silicone group (i.e., the polyamine is not of Formula (X)).

Any polyisocyanate that can react with the above-described polydiorganosiloxane diamine can be used. The polyisocyanates are typically diisocyanates but small amounts of triisocyanates can be included. Examples of suitable diisocyanates include aromatic diisocyanates such as 2,6-toluene diisocyanate, 2,5-toluene diisocyanate, 2,4-toluene diisocyanate, m-phenylene diisocyanate, p-phenylene diisocyanate, methylenediphenylene-4,4′-diisocyanate, polycarbodiimide-modified methylenediphenylene diisocyanate, (4,4′-diisocyanato-3,3′,5,5′-tetraethyl) diphenylmethane, 4,4-diisocyanato-3,3′-dimethoxybiphenyl (o-dianisidine diisocyanate), 5-chloro-2,4-toluene diisocyanate, 1-chloromethyl-2,4-diisocyanato benzene, m-xylylene diisocyanate and tetramethyl-m-xylylene diisocyanate; and aliphatic diisocyanates such as 1,4-diisocyanatobutane, 1,6-diisocyanatohexane, 1,12-diisocyanatododecane, and 2-methyl-1,5-diisocyanatopentane; and cycloaliphatic diisocyanates such as methylenedicyclohexylene-4,4′-diisocyanate, 3-isocyanatomethyl-3,5,5-trimethylcyclohexyl isocyanate (isophorone diisocyanate), and cyclohexylene-1,4-diisocyanate. Examples of suitable triisocyanates include those produced from biurets, isocyanurates, and adducts. Examples of commercially available polyisocyanates include portions of the series of polyisocyanates available under the trade designations DESMODUR and MONDUR from Bayer (Whippany, N.J.) and PAPI from Dow Plastics (Midland, Mich., USA).

Examples of useful optional organic polyamines include polyoxyalkylene diamines such as those commercially available under the trade designation D-230, D-400, D-2000, D-4000, ED-2001 and EDR-148 from Huntsman Corporation (The Woodlands, Tex., USA), polyoxyalkylene triamines such as those commercially available under the trade designations T-403, T-3000 and T-5000 from Huntsman Corporation, alkylene diamines such as ethylene diamine, and various polyamines commercially available from INVISTA Intermediates and Specialty Materials (Wilmington, Del., USA) under the trade designation DYTEK (e.g., DYTEK A is 2-methylpentamethylenediamine and DYTEK EP is 1,3-pentanediamine).

The silicone polyurea block copolymers can be represented by the repeating unit of Formula (IX) with a urea linkage of formula —NH—(CO)—ND-.

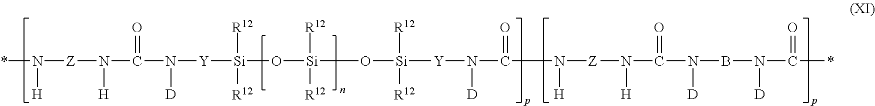

The groups R¹² and Y as well as the variable n are the same as defined above for the polydiorganosiloxane of Formula (X). Each D is selected from hydrogen, an alkyl (e.g., an alkyl having 1 to 10 carbon atoms, 1 to 6 carbon atoms, or 1 to 4 carbon atoms), an aryl having 6 to 12 carbon atoms (e.g., phenyl), or a radical that completes a ring structure including B or Y to form a heterocycle. Each D is often hydrogen or an alkyl group.

Each group Z in Formula (XI) is equal to the polyisocyanate minus the multiple isocyanate groups (e.g., minus the two isocyanate groups). In many embodiments, each Z is independently an arylene, aralkylene, or alkylene. Exemplary arylenes have 6 to 20 carbon atoms and exemplary aralkylenes have 7 to 20 carbon atoms. The arylenes and aralkylenes can be unsubstituted or substituted with an alkyl (e.g., an alkyl having 1 to 10 carbon atoms, 1 to 6 carbon atoms, or 1 to 4 carbon atoms), an alkoxy (e.g., an alkoxy having 1 to 10 carbon atoms, 1 to 6 carbon atoms, or 1 to 4 carbon atoms), or halo (e.g., chloro, bromo, or fluoro). The alkylenes can be linear branch, cyclic, or combinations thereof and can have 1 to 20 carbon atoms. In some embodiments Z is 2,6-tolylene, 4,4′-methylenediphenylene, 3,3′-dimethoxy-4,4′-biphenylene, tetramethyl-m-xylylene, 4,4′-methylenedicyclohexylene, 3,5,5-trimethyl-3-methylenecyclohexylene, 1,6-hexamethylene, 1,4-cyclohexylene, 2,2,4-trimethylhexylene, and mixtures thereof.

If no optional organic polyamine is used, the variable m in Formula (XI) is equal to zero. If an organic polyamine is used, the variable m in Formula (I) has a value greater than zero. For example, m is in a range of 0 to 1000, in a range of 0 to 500, in a range of 0 to 200, in a range of 0 to 100, in a range of 0 to 50, in a range of 0 to 20, or in a range of 0 to 10.

The group B in Formula (XI) is equal to the polyamine minus the multiple amine groups (e.g., minus two amine groups). Group B is often selected from an alkylene (e.g., an alkylene having 1 to 10 carbon atoms, 1 to 6 carbon atoms, or 1 to 4 carbon atoms), aralkylene, arylene such as phenylene, or heteroalkylene. Examples of heteroalkylenes include divalent radicals of polyethylene oxide (also called poly(oxyethylene)), polypropylene oxide (also called poly(oxypropylene)), polytetramethylene oxide (also called poly(oxytetramethylene)), and copolymers and mixtures thereof.

The variable p is a number that is at least 1 such as 1 to 10, 1 to 5, or 1 to 3. Each asterisk (*) indicates a site of attachment of the repeat unit to another group in the copolymer such as, for example, another repeat unit of Formula (XI).

Useful silicone polyurea block copolymers are disclosed, for example, in U.S. Pat. No. 5,512,650 (Leir et al.), U.S. Pat. No. 5,214,119 (Leir et al.), U.S. Pat. No. 5,461,134 (Leir et al.), U.S. Pat. No. 6,407,195 (Sherman et al.), U.S. Pat. No. 6,441,118 (Sherman et al.), U.S. Pat. No. 6,846,893 (Sherman et al.), and U.S. Pat. No. 7,153,924 (Kuepfer et al.) as well as in PCT Publication No. WO 97/40103 (Paulick et al.).

A second example of a useful silicone-based silicone polymer is a polydiorganosiloxane polyoxamide block copolymer. Polydiorganosiloxane polyoxamide block copolymers are typically the reaction product of a silicone diamine such as that shown in Formula (X), an oxalate compound, and an organic polyamine (e.g., an organic diamine). Examples of polydiorganosiloxane polyoxamide block copolymers are described, for example, in U.S. Patent Application Publication No. 2007/0148474 (Leir et al.). The polydiorganosiloxane polyoxamide block copolymer contains at least two repeat units of Formula (XII).

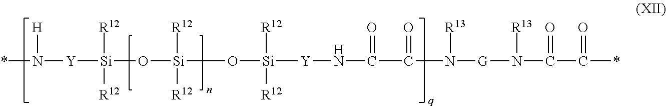

In Formula (XII), group Y, group R¹², and variable n are the same as described above for Formula (X). That is, each R¹² is independently an alkyl, haloalkyl, aralkyl, alkenyl, aryl, or aryl substituted with an alkyl, alkoxy, or halo. Each asterisk (*) indicates a site of attachment of the repeat unit to another group in the copolymer such as, for example, another repeat unit of Formula (XII).

The subscript q is an integer of 1 to 10. For example, the value of q is often an integer up to 9, up to 8, up to 7, up to 6, up to 5, up to 4, up to 3, or up to 2. The value of q can be in the range of 1 to 8, 1 to 6, or 1 to 4.

Group G in Formula (XII) is a residual unit that is equal to a diamine compound of formula R¹³HN-G-NHR¹³ minus the two amino groups (i.e., —NHR⁸ groups). Group R¹³ is hydrogen or alkyl (e.g., an alkyl having 1 to 10, 1 to 6, or 1 to 4 carbon atoms) or R¹³ taken together with G and with the nitrogen to which they are both attached forms a heterocyclic group (e.g., R¹³HN-G-NHR¹³ is piperazine or the like). The diamine can have primary or secondary amino groups. In most embodiments, R¹³ is hydrogen or an alkyl. In many embodiments, both of the amino groups of the diamine are primary amino groups (i.e., both R¹³ groups are hydrogen) and the diamine is of formula H₂N-G-NH₂.

In some embodiments, G is an alkylene, heteroalkylene, polydiorganosiloxane, arylene, aralkylene, or a combination thereof. Suitable alkylenes often have 2 to 10, 2 to 6, or 2 to 4 carbon atoms. Exemplary alkylene groups include ethylene, propylene, butylene, and the like. Suitable heteroalkylenes are often polyoxyalkylenes such as polyoxyethylene having at least 2 ethylene units, polyoxypropylene having at least 2 propylene units, or copolymers thereof Suitable polydiorganosiloxanes include the polydiorganosiloxane diamines of Formula (X), which are described above, minus the two amino groups. Exemplary polydiorganosiloxanes include, but are not limited to, polydimethylsiloxanes with alkylene Y groups. Suitable aralkylene groups usually contain an arylene group having 6 to 12 carbon atoms bonded to an alkylene group having 1 to 10 carbon atoms. Some exemplary aralkylene groups are phenylene-alkylene where the phenylene is bonded to an alkylene having 1 to 10 carbon atoms, 1 to 8 carbon atoms, 1 to 6 carbon atoms, or 1 to 4 carbon atoms. As used herein with reference to group G, “a combination thereof” refers to a combination of two or more groups selected from an alkylene, heteroalkylene, polydiorganosiloxane, arylene, and aralkylene. A combination can be, for example, an aralkylene bonded to an alkylene (e.g., alkylene-arylene-alkylene). In one exemplary alkylene-arylene-alkylene combination, the arylene is phenylene and each alkylene has 1 to 10, 1 to 6, or 1 to 4 carbon atoms.

The polydiorganosiloxane polyoxamide tends to be free of groups having a formula —R^{a}—(CO)—NH— where R^{a} is an alkylene. All of the carbonylamino groups along the backbone of the copolymeric material are part of an oxalylamino group (i.e., the —(CO)—(CO)—NH— group). That is, any carbonyl group along the backbone of the copolymeric material is bonded to another carbonyl group and is part of an oxalyl group. More specifically, the polydiorganosiloxane polyoxamide has a plurality of aminoxalylamino groups.

A third example of useful silicone-based silicone polymers are amide-based silicone copolymers. Such polymers are similar to the urea-based polymers, containing amide linkages (—N(D)-(CO)— with the carbonyl group bonded to an alkylene or arylene group) instead of urea linkages (—N(D)-(CO)—NH—). Group D is the same as defined above for Formula (XI) and is often hydrogen or alkyl.

The amide-based silicone copolymers may be prepared in a variety of different ways. Starting from the polydiorganosiloxane diamine described above in Formula (X), the amide-based copolymer can be prepared by reaction with a poly(carboxylic acid) or a poly(carboxylic acid) derivative such as, for example, esters of the poly(carboxylic acid). In some embodiments, the amide-based silicone elastomer is prepared by the reaction of a polydiorganosiloxane diamine and dimethyl salicylate of adipic acid.

An alternative reaction pathway to amide-based silicone elastomers utilizes a silicone dicarboxylic acid derivative such as a carboxylic acid ester. Silicone carboxylic acid esters can be prepared through the hydrosilation reaction of a silicone hydride (i.e., a silicone terminated with a silicon-hydride (Si—H) group) and an ethylenically unsaturated ester. For example a silicone di-hydride can be reacted with an ethylenically unsaturated ester such as, for example, CH₂═CH—(CH₂)ᵥ—(CO)—OR, where —(CO)— represents a carbonyl group and v is an integer up to 15, and R is an alkyl, aryl or substituted aryl group, to yield a silicone chain capped with —Si—(CH₂)ᵥ₊₂—(CO)—OR. The —(CO)—OR group is a carboxylic acid derivative which can be reacted with a silicone diamine, a polyamine or a combination thereof Suitable silicone diamines and polyamines have been discussed above and include aliphatic, aromatic or oligomeric diamines (such as ethylene diamine, phenylene diamine, xylylene diamine, polyoxalkylene diamines, etc.).

Another useful class of silicone elastomers is urethane-based silicone polymers such as silicone polyurea-urethane block copolymers. Silicone polyurea-urethane block copolymers include the reaction product of a polydiorganosiloxane diamine (also referred to as silicone diamine), a diisocyanate, and an organic polyol. Such materials are structurally very similar to the structure of Formula (IX) except that the —N(D)-B—N(D)- links are replaced by —O—B—O— links. Examples are such polymers are further described in U.S. Pat. No. 5,214,119 (Leir et al.). These urethane-based silicone polymers are prepared in the same manner as the urea-based silicone polymers except that an organic polyol is substituted for the organic polyamine. Typically, since the reaction between an alcohol and an isocyanate is slower than the reaction between an amine and an isocyanate, a catalyst is used. The catalyst is often a tin-containing compound.

Another class of thermoplastic polymers for use in coating solutions where the nitrogen-containing curing agent is polar (e.g., hydrophilic) are (meth)acrylate-based polymers. In many embodiments, the monomers used to form the (meth)acrylate-based polymers are alkyl (meth)acrylates. For example, at least 90 weight percent, at least 95 weight percent, at least 98 weight percent, at least 99 weight percent, or 100 weight percent of the monomers are alkyl (meth)acrylates. These polymers can be dissolved in organic solvents such as, for example, toluene, benzene, alkanes (e.g., pentane, cyclohexane, or hexane), and chlorinated solvents such as chloroform and dichloromethane.

The alkyl (meth)acrylates are typically those having an alkyl group with 1 to 20 carbon atoms. The alkyl group can be linear, branched, cyclic, or a combination thereof. Suitable examples include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, isopentyl (meth)acrylate, 2-methylbutyl (meth)acrylate, n-hexyl (meth)acrylate, cyclohexyl (meth)acrylate, 4-methyl-2-pentyl (meth)acrylate, 2-methylhexyl (meth)acrylate, 3,3,5-trimethylcyclohexyl (meth)acrylate, isobornyl (meth)acrylate, 2-ethylhexyl (meth)acrylate, n-octyl (meth)acrylate, isooctyl (meth)acrylate, 2-octyl (meth)acrylate, isononyl (meth)acrylate, isoamyl (meth)acrylate, n-decyl (meth)acrylate, isodecyl (meth)acrylate, 2-propylheptyl (meth)acrylate, isotridecyl (meth)acrylate, isostearyl (meth)acrylate, octadecyl (meth)acrylate, 2-octyldecyl (meth)acrylate, dodecyl (meth)acrylate, lauryl (meth)acrylate, and heptadecanyl (meth)acrylate. In many embodiments, the alkyl (meth)acrylate is an alkyl methacrylate.

The alkyl methacrylates tend to have a higher glass transition temperature than alkyl acrylates and so may be more suitable for use in preparation of the (meth)acrylate-based polymer. However, some alkyl acrylates can be included in the (meth)acrylate as long as the glass transition temperature is at least 20° C., at least 40° C., at least 50° C., at least 60° C., at least 80° C., or at least 100° C. Specific examples of (meth)acrylate polymers include various homopolymers such as, for example, poly(methyl methacrylate), poly(ethyl methacrylate), and polybutyl methacrylate as well as various copolymers such as, for example, poly(butyl methacrylate)-co-poly(isobutyl methacrylate) and the like. Such polymers can be obtained, for example, from Polysciences, Inc. (Warrington, Pa., USA).

Any suitable molecular weight can be used for the (meth)acrylate-based polymer. The molecular weight should be high enough to form a film but not so high that the (meth)acrylate-based polymer is difficult to dissolve in an organic solvent or that the resulting solution has a viscosity that is too high for deposition on the porous core polymeric particles. The weight average molecular weight is often at least 1,000 Daltons (grams/mole), at least 2,000 Daltons, at least 5,000 Daltons, at least 10,000 Daltons, or at least 20,000 Daltons. The weight average molecular weight can be, for example, up to 500,000 Daltons or higher, up to 400,000 Daltons, up to 200,000 Daltons, or up to 100,000 Daltons.

Olefin-based polymers are yet another class of thermoplastic polymers that can be used in coating solutions where the nitrogen-containing curing agent is polar (e.g., hydrophilic). In many embodiments, the olefin-based polymers are polyethylene, polypropylene, polybutylene, or copolymers thereof. These polymers can have any suitable molecular weight that can be dissolved in a suitable solvent. The weight average molecular weight is often in a range of 1,000 to 500,000 Daltons.

In other embodiments where the loaded nitrogen-containing curing agent is a polar compound, the coating solution can contain a wax dissolved in an organic solvent such as toluene, benzene, an alkane, an alcohol, or the like. The wax can be a naturally occurring or synthetic material. Example waxes include, but are not limited to, animal waxes such as beeswax and lanolin, vegetable waxes such as Carnauba wax, petroleum waxes such as paraffin, and hydrogenated oils such as hydrogenated vegetable oils. Example hydrogenated oils include hydrogenated castor oil such as that commercially available under the trade designation CASTORWAX from Vertellus (Indianapolis, Ind., USA). Still other waxes are polyethylene such as those, for example, of formula CH₃—(CH₂)ₘ—CH₃ where m is in a range of about 50 to 100.

In still other embodiments, the nitrogen-containing curing agent is a non-polar compound (e.g., hydrophobic compound) and the coating solution contains a thermoplastic polymer dissolved in water or a polar organic solvent such as, for example, an alcohol (e.g., methanol, ethanol, n-propanol, isopropanol, n-butanol, and the like), tetrahydrofuran, acetonitrile, dimethylformamide, dimenthylsulfoxide, dichloromethane, propylene carbonate, acetone, methyl ethyl ketone, methyl isobutyl ketone, or the like. In many embodiments, the coating solution contains water and/or an alcohol. The amount of thermoplastic polymer in the solution depends on the desired viscosity of the solution and the solubility of the thermoplastic polymer in water and/or polar organic solvent. In many embodiments, the thermoplastic polymer is present in an amount equal to at least 5 weight percent, at least 10 weight percent, or at least 15 weight percent and up to 50 weight percent, up to 40 weight percent, up to 30 weight percent, or up to 20 weight percent based on a total weight of the thermoplastic polymer solution.

Suitable thermoplastic polymers include, but are not limited to, poly(vinylpyrrolidone) (PVP), copolymers of vinylpyrrolidone and vinyl acetate, (meth)acrylate-based polymers with acidic groups (such as copolymers of an alkyl (meth)acrylate as described above and (meth)acrylic acid), polyesters, polyamides, and polyvinyl alcohols. The weight average molecular weight is often at least 1,000 Daltons, at least 2,000 Daltons, at least 5,000 Daltons, or at least 10,000 Daltons. The weight average molecular weight can be up to 500,000 Daltons or higher. For example, the weight average molecular weight can be up to 300,000 Daltons, up to 200,000 Daltons, up to 100,000 Daltons, up to 50,000 Daltons, up to 20,000 Daltons. Some such thermoplastic polymers can be obtained, for example, from Polysciences, Inc. (Warrington, Pa., USA).

In still other embodiments, a coating dispersion is used to form the coating layer. The coating dispersion is often a water-based dispersion of a wax and/or thermoplastic polymer. These dispersions often have percent solids in the range of 10 to 60 weight percent, 20 to 50 weight percent, or 30 to 40 weight percent. The high percent solids content of the water-based dispersions tends to disfavor extraction of the nitrogen-containing curing agent from the porous polymeric core, even when the nitrogen-containing curing agent is soluble in water.

An example water-based dispersion of a thermoplastic polymer contains phenoxy resin (polyhydroxy ethers) such as those formed from epichlorohydrin and Bisphenol A. Such water-based dispersions are commercially available from InChem (Rock Hill, S.C., USA) under the trade designation PKHW (e.g., PKHW 34, PKHW 35, and PKHW 38) and PKHP (e.g., PKHP 200).

Still other water-based dispersions contain olefin-based polymers such as polyethylene, polypropylene, polybutylene, or copolymers thereof. In some embodiments, the olefin-based polymers are polyethylene such as low density polyethylene (LDPE) or high density polyethylene (HDPE). In some embodiments, the weight average molecular weight of the dispersed olefin-based polymer is at least 2,000 grams/mole, at least 5,000 grams/mole, at least 10,000 grams/mole, at least 20,000 grams/mole, or at least 50,000 grams/mole. The weight average molecular weight can be up to 500,000 grams/mole or higher, up to 200,000 grams/mole, or up to 100,000 grams/mole. These materials can be obtained under the trade designation SYNCERA from Paramelt (Muskegon, Mich., USA), under the trade designation LIQUITRON from Lubrizol Advanced Materials, Inc. (McCook, Ill., USA).

Wax dispersions typically contain a wax having a hydrophilic group that allows dispersion in water. Examples include dispersions of polyethylene, paraffin waxes, Carnauba wax, and the like. Such materials are commercially available under the trade designation SYNCERA from Paramelt (Muskegon, Mich., USA), under the trade designation LIQUITRON from Lubrizol Advanced Materials, Inc. (McCook, Ill., USA), and under the trade designation CARNAUBA MILK from Koster Keunen (Watertown, Conn., USA).

Any suitable method can be used to deposit the coating around the polymeric core particle. In most embodiments, the porous polymeric core particles contains loaded nitrogen-containing curing agent at the time the coating layer is deposited. That is, the coating layer is formed around loaded polymeric core particles. The coating solution or coating dispersion is mixed with the porous polymeric core particles (e.g., loaded polymeric core particles). After sufficient mixing, the solvent is removed to provide a coating layer. The resulting particles are composite particles if the polymeric core particles were loaded with a nitrogen-containing curing agent.

For many embodiments of the composite particles, the coating layer surrounds the loaded porous polymeric core particle as a shell layer. Stated differently, the composite particles are core-shell polymeric particles. Prior to release of the nitrogen-containing curing agent, the porous composite particles have a core-shell structure with the porous polymeric core particles containing the loaded nitrogen-containing curing agent. In some embodiments, the shell layer (coating layer) surrounds a single porous polymeric core particle. That is, the composite particle contains a single porous polymeric core particle (or loaded core particle). In other embodiments, however, the shell surrounds multiple polymeric core particles (or loaded core particles). That is, the composite particle contains multiple polymeric core particles (or loaded core particles) within a common shell layer (coating layer).

The polymeric core particles, including loaded polymeric core particles, are not tacky. This increases the likelihood that multiple polymeric core particles will not adhere together before or during application of the coating layer. That is, the lack of tackiness of the porous core particles (or loaded core particles) increases the likelihood that the coating layer will be positioned around a single polymeric core particle rather than around multiple polymeric core particles.

The coating layer is formed by mixing a coating solution or coating dispersion with the porous polymeric core particle (or loaded polymeric core particles). The coating solution or coating dispersion can have any desired percent solids that allow good mixing with the polymeric core particles. In many embodiments, the maximum percent solids often correspond to the coating solution or dispersion having the highest viscosity that can be pumped. High solids can be desirable because less solvent or water needs to be removed during the process of forming the coating layer. If the percent solids value is too high, however, it is more likely that the coating layer will surround multiple polymeric core particles (or loaded core particles). In many embodiments, dilute coating solutions or coating dispersions are used to increase the likelihood of forming composite particles containing a single polymeric core particle (or loaded core particle).

The coating solution or coating dispersion often contains at least 5 weight percent, at least 10 weight percent, at least 15 weight percent, or at least 20 weight percent solids. The weight percent solids corresponds to the weight percent thermoplastic polymer and/or wax in the coating solution or coating dispersion. The weight percent solids can be up to 70 weight percent or even higher, up to 60 weight percent, up to 50 weight percent, up to 40 weight percent, or up to 30 weight percent. For example, the weight percent solids can be in a range of 10 to 70 weight percent, 20 to 60 weight percent, 20 to 50 weight percent, or 20 to 40 weight percent.

Spray drying (spray coating and drying) or similar processes such as fluidized bed coating and drying that can result in the formation of a coating layer with relatively uniform thickness around the polymeric core particles is often considered to be preferable. If conditions are selected appropriately, these processes can be used to provide composite particles having a single rather than multiple porous polymeric core particles (or loaded core particles). That is, the composite particles have a core-shell arrangement with a coating layer around a single porous polymeric core particle.

With spray drying, the polymeric core particles (or loaded core particles) are mixed with the coating solution or coating dispersion to form a slurry. This slurry is then pumped to a drying chamber that contains an atomizer (to form droplets) and a drying gas. Some common types of atomization include rotary wheel (centrifugal) atomization, single-fluid/pressure nozzle (hydraulic) atomization, two-fluid nozzle (pneumatic) atomization, and ultrasonic atomization. The product, which is the dried composite particles, can be collected by various means such as by gravity or by using a cyclone, filter and bag, electrostatic separation, or the like.

Although any suitable atomization process can be used, two-fluid nozzle atomizers are often used. With these atomizers, a primary fluid (e.g., the slurry) is pumped through a small orifice and a second fluid, which is typically air or nitrogen, is supplied near the small orifice to further atomize the primary fluid. Increasing the ratio of the secondary fluid to the primary fluid usually decreases the slurry droplet size and increases the likelihood of having a single polymeric core particle within the coating layer.

The two-fluid system may have either internal mixing (the second fluid is introduced into the primary fluid before exiting the final orifice) or external mixing (the second fluid is introduced after the primary fluid exits the final orifice). Multiple different configurations can be used for introducing the second fluid relative to the primary fluid. For example, the configuration can be a round spray (concentric ring of the second fluid surrounding the primary fluid orifice), conical/hollow spray, angle/flat spray, swirl spray, or the like. Atomizers with these different configurations are available from various suppliers such as Spraying Systems Co. (Wheaton, Ill., USA).

Numerous options can be used for the flow of the bulk drying gas into and out of the drying chamber. To maintain sufficient thermal energy and to provide a drying gas with sufficient drying capacity (e.g., low dew point), the drying gas is usually continuously cycled through the drying chamber. The main classes of flow patterns of the drying gas relative to the atomized droplets (input material) are co-current flow, counter-current flow, and mixed flow. Co-current flow involves the input material traveling in the same direction as the bulk drying gas; this is often embodied as input material travelling downward immediately after atomization (e.g., being sprayed downward) along with the downward-travelling bulk drying gas. Co-current is usually good for temperature-sensitive systems because the hot drying gas is cooled by the drying droplets, so the solid materials never experience the temperature of the hot incoming drying gas. Counter-current flow involves the input material travelling in the opposite direction to the bulk drying gas; this is often embodied as input material travelling downward immediately after atomization (e.g., being sprayed downward) while the bulk drying gas is travelling upward. This flow is often used for the most efficient drying. Mixed flow is a combination of co- and counter-current flow, where the input material is travelling in the same direction as the bulk drying gas in some regions, but in the opposite direction in other regions. Most often this flow pattern is seen when the input material is being atomized in an upward direction, where the input material initially travels upward from the energy imparted on it by atomization, but is subsequently pulled downward by gravity. Because the input material travels in two directions, the bulk drying gas will travel with the input material in some places and against the input material in others, regardless of whether the bulk drying gas is traveling downward or upward. Mixed flow can be advantageous because of the higher residence times in the drying chamber it provides to the drying solids.

The drying temperature is usually selected based on the composition of the loaded polymeric core particles and the coating solution or dispersion. In many embodiments, the bulk drying gas at the outlet of the drying chamber has a temperature near the boiling point of the water or organic solvent used in the slurry (in the coating solution or dispersion) to ensure that adequate drying occurs. This does result, however, in the dried solids reaching a temperature that is near the boiling point of the water or organic solvent. In most instances, this can be beneficial because it minimizes residual liquids, which can lead to improved flowability, reduced hazards from volatile organic solvents being present, and reduction of unnecessary mass.

For some composite particles, however, it may be undesirable to use such a high drying temperature. This can be the situation, for example, where any component of the composite particles has a glass transition temperature, melting temperature, or decomposition temperature near the boiling point of the water or organic solvent contained in the slurry. In particular, care must be taken to prevent or minimize release of the nitrogen-containing curing agent from the composite particle. In such a situation, the drying temperature is typically reduced below that where any undesirable alteration of the composite particle can occur. Drying can be accomplished at lower temperatures, for example, by increasing the residence time in the drying chamber, increasing the flow rate of the drying gas, decreasing the evaporative load, or modifying the various flow patterns.

Multiple coating layers can be positioned around the porous polymeric core particle (or loaded core particles). Often, multiple layers are added to provide a thicker coating layer or to alter the release characteristics of the nitrogen-containing curing agent from the porous composite particle. If multiple coating layers are used, they are usually selected to be compatible with each other. In many embodiments, the same thermoplastic material and/or wax is used to form the multiple coating layers.

The coating layer can have any desired thickness. In some embodiments, the thickness is at least 0.1 micrometers, at least 0.2 micrometers, at least 0.5 micrometers, at least 0.75 micrometers, or at least 1.0 micrometers. The thickness can be up to 5 micrometers or more, up to 4 micrometers, up to 3 micrometers, or up to 2 micrometers. The release profile of the nitrogen-containing curing agent within the composite particle usually can be controlled by the thickness of the coating layer. That is, the greater the thickness, the slower the release rate of the nitrogen-containing curing agent through the coating layer. On the other hand, the release rate of the nitrogen-containing curing agent can be increased by decreasing the coating layer thickness. The thickness is frequently in a range of 0.1 to 5 micrometers, in a range of 0.1 to 3 micrometers, in a range of 0.5 to 5 micrometers, in a range of 0.5 to 3 micrometers, in a range of 1 to 5 micrometers, in a range of 1 to 3 micrometers, in a range of 0.1 to 2 micrometers, in a range of 0.5 to 2 micrometers, or in a range of 1 to 2 micrometers.

As an alternative to spray drying or similar processes, a mixture of the polymeric core particles (or loaded core particles) and either the coating solution or the coating dispersion can be spread out into a thin layer for drying purposes. Any suitable drying method can be used. The dried layer can then be broken apart to provide the composite particles. For example, the dried layer can be placed within a blender or dry mill to separate the particles from each other. The percent solids in the thin layer are typically relatively low to decrease the likelihood of having multiple polymeric core particles (or loaded core particles) within the same porous composite particle. This method can be used when relatively uniform coating layer thicknesses are not necessary or where a variety of coating thicknesses may be desired to provide a wider distribution of release rates for nitrogen-containing curing agent. Additionally, this method can be used when it may be beneficial to have multiple polymeric core particles (or loaded core particles) surrounded by the same coating layer to provide a distribution of release rates.

The composite particle typically contains at least 20 weight percent porous polymeric core particle, at least 0.1 weight percent nitrogen-containing curing agent, and at least 10 weight percent coating layer based on the total weight of the porous composite particle. In some examples, the composite particle can contain at least 30 weight percent porous polymeric core particle, at least 0.5 weight percent nitrogen-containing curing agent, and at least 20 weight percent coating layer. In other examples, the composite particle can contain at least 40 weight percent porous polymeric core particle, at least 1 weight percent nitrogen-containing curing agent, and at least 30 weight percent coating layer.

The composite particle typically contains up to 90 weight percent porous polymeric core particle, up to 70 weight percent nitrogen-containing curing agent, and up to 80 weight percent coating layer. In some example, the composite particle can contain up to 80 weight percent porous polymeric core particle, up to 50 weight percent nitrogen-containing curing agent, and up to 70 weight percent coating layer. In other examples, the composite particle can contain up to 70 weight percent porous polymeric core particle, up to 40 weight percent nitrogen-containing curing agent, and up to 60 weight percent coating layer.

In some embodiments, the composite particle contains 20 to 90 weight percent porous polymeric core particle, 1 to 70 weight percent nitrogen-containing curing agent, and 10 to 80 weight percent coating layer. In some examples, the composite particle contains 30 to 80 weight percent porous polymeric particle, 1 to 50 weight percent nitrogen-containing curing agent, and 20 to 70 weight percent coating layer. In other example, the composite particles contain 30 to 75 weight percent porous polymeric particle, 5 to 50 weight percent nitrogen-containing curing agent, and 25 to 70 weight percent coating layer. In still other examples, the composite particle contains 30 to 70 weight percent porous polymeric particle, 5 to 40 weight percent nitrogen-containing curing agent, and 30 to 70 weight percent coating layer.

The composite particles are mixed with the epoxy resin. While any suitable amount of the composite particles can be combined with the epoxy resin, the amount is typically dependent on the amount and type of nitrogen-based curing agent loaded into the composite particle. For example, larger amounts of the nitrogen-containing curing agent are needed if it is a compound having at least two groups of formula —NR⁷H than if it is a secondary curative such as imidazoles or salts thereof or imidazolines or salts, substituted ureas (e.g., bis-substituted ureas), or phenols substituted with tertiary amino groups. Compounds having at least two groups of formula —NR⁷H tend to react directly with the epoxy resin while the secondary curatives often function as catalysts for the ring opening reactions of the oxirane groups.

In many embodiments, the amount of composite particles included in the composition is at least 0.1 weight percent based on the combined weight of the composite particles and the epoxy resin. If lower amounts are used, there may be an insufficient amount of the nitrogen-containing curative to polymerize the epoxy resin. The amount of the composite particles can be, for example, at least 0.5 weight percent, at least 1 weight percent, at least 2 weight percent, or at least 5 weight percent. The amount of the composite particles can be up to 35 weight percent. If the amount of the composite particles is higher, the final cured composition may be too soft (it may have lower than the desired amount of strength integrity). The amount of the composite particles can be, for example, up to 30 weight percent, up to 25 weight percent, up to 20 weight percent, up to 15 weight percent, or up to 10 weight percent. In some example embodiments, the amount is in a range of 0.1 to 35 weight percent, in a range of 0.5 to 35 weight percent, in a range of 0.5 to 30 weight percent, in a range of 0.5 to 25 weight percent, in a range of 0.5 to 20 weight percent, in a range of 0.5 to 10 weight percent, in a range of 1 to 30 weight percent, in a range of 1 to 20 weight percent, or in a range of 1 to 10 weight percent.

In addition to the epoxy resin and the composite particles, the curable composition can include various optional components. One such optional component is a toughening agent. Toughening agents can be added to provide the desired overlap shear, peel resistance, and impact strength. Useful toughening agents are polymeric materials that may react with the epoxy resin and that may be cross-linked. Suitable toughening agents include polymeric compounds having both a rubbery phase and a thermoplastic phase or compounds which are capable of forming, with the epoxide resin, both a rubbery phase and a thermoplastic phase on curing. Polymers useful as toughening agents are preferably selected to inhibit cracking of the cured epoxy composition.

Some polymeric toughening agents that have both a rubbery phase and a thermoplastic phase are acrylic core-shell polymers wherein the core is an acrylic copolymer having a glass transition temperature below about 0° C. Such core polymers may include polybutyl acrylate, polyisooctyl acrylate, polybutadiene-polystyrene in a shell comprised of an acrylic polymer having a glass transition temperature above about 25° C., such as polymethylmethacrylate. Commercially available core-shell polymers include those available as a dry powder under the trade designations ACRYLOID KM 323, ACRYLOID KM 330, and PARALOID BTA 731, from Dow Chemical Co., and KANE ACE B-564 from Kaneka Corporation (Osaka, Japan). These core-shell polymers may also be available as a predispersed blend with a diglycidyl ether of bisphenol A at, for example, a ratio of 12 to 37 parts by weight of the core-shell polymer and are available under the trade designations KANE ACE (e.g., KANE ACE MX 157, KANE ACE MX 257, and KANE ACE MX 125) from Kaneka Corporation (Japan).

Another class of polymeric toughening agents which are capable of forming, with the epoxide group-containing material, both a rubbery phase and a thermoplastic phase on curing are carboxyl-terminated butadiene acrylonitrile compounds. Commercially available carboxyl-terminated butadiene acrylonitrile compounds include those available under the trade designations HYCAR (e.g., HYCAR 1300X8, HYCAR 1300X13, and HYCAR 1300X17) from Lubrizol Advanced Materials, Inc. (Cleveland, Ohio, USA) and under the trade designation PARALOID (e.g., PARALOID EXL-2650) from Dow Chemical (Midland, Mich., USA).

Other polymeric toughening agents are graft polymers, which have both a rubbery phase and a thermoplastic phase, such as those disclosed in U.S. Pat. No. 3,496,250 (Czerwinski). These graft polymers have a rubbery backbone having grafted thereto thermoplastic polymer segments. Examples of such graft polymers include, for example, (meth)acrylate-butadiene-styrene, and acrylonitrile/butadiene-styrene polymers. The rubbery backbone is preferably prepared so as to constitute from about 95 percent to about 40 percent by weight of the total graft polymer, so that the polymerized thermoplastic portion constitutes from about 5 percent to about 60 percent by weight of the graft polymer.

Still other polymeric toughening agents are polyether sulfones such as those commercially available from BASF (Florham Park, N.J., USA) under the trade designation ULTRASON (e.g., ULTRASON E 2020 P SR MICRO).

The curable composition can additionally contain a non-reactive plasticizer to modify rheological properties. Commercially available plasticizers include those available under the trade designation BENZOFLEX 131 from Eastman Chemical (Kingsport, Tenn., USA), JAYFLEX DINA available from ExxonMobil Chemical (Houston, Tex., USA), and PLASTOMOLL (e.g., diisononyl adipate) from BASF (Florham Park, N.J., USA).

The curable composition optionally contains a flow control agent or thickener, to provide the desired rheological characteristics to the composition. Suitable flow control agents include fumed silica, such as treated fumed silica, available under the trade designation CAB-O-SIL TS 720, and untreated fumed silica available under the trade designation CAB-O-SIL M5, from Cabot Corporation (Alpharetta, Ga., USA).

In some embodiments, the curable composition optimally contains adhesion promoters to enhance the bond to the substrate. The specific type of adhesion promoter may vary depending upon the composition of the surface to which it will be adhered. Adhesion promoters that have been found to be particularly useful for surfaces coated with ionic type lubricants used to facilitate the drawing of metal stock during processing include, for example, dihydric phenolic compounds such as catechol and thiodiphenol.

The curable composition optionally may also contain one or more conventional additives such as fillers (e.g., aluminum powder, carbon black, glass bubbles, talc, clay, calcium carbonate, barium sulfate, titanium dioxide, silica such as fused silica, silicates, glass beads, and mica), fire retardants, antistatic materials, thermally and/or electrically conductive particles, and expanding agents including, for example, chemical blowing agents such as azodicarbonamide or expandable polymeric microspheres containing a hydrocarbon liquid, such as those sold under the trade designation EXPANCEL by Expancel Inc. (Duluth, Ga., USA). Particulate fillers can be in the form of flakes, rods, spheres, and the like. Additives are typically added in amounts to produce the desired effect in the resulting adhesive.

In another aspect, a cured composition is provided. The cured composition contains the reaction product (polymerized product) of a curable composition that contains an epoxy resin and a composite particle mixed with the epoxy resin. The composite particle contains 1) a porous polymeric core, 2) a nitrogen-containing curing agent for the epoxy resin that is positioned within the porous polymeric core but not chemically bound to the porous polymeric core, and 3) a coating layer around the porous polymeric core, wherein the coating layer comprises a thermoplastic polymer, a wax, or a mixture thereof. Any of the above described curable compositions can be used to prepare the curable compositions.

In many embodiments, the curable composition is positioned between two substrates and then heated to cause diffusion of the nitrogen-containing curing agent from the composite particle. The heating may soften or melt the coating layer of the composite particle further enhancing diffusion of the nitrogen-containing curing agent from the composite particle. Upon diffusion from the composite particle, the nitrogen-containing curing agent contacts the epoxy resin in the curable composition. If the conditions are suitable for reaction, the nitrogen-containing curing agent can react with the epoxy resin resulting in the formation of a cured composition. Conditions suitable for reaction include, for example, having a sufficient concentration of nitrogen-containing curing agent mixed with the epoxy resin and having a sufficient temperature for curing the epoxy resin.

Substrates can be selected from various materials depending on the application. Materials useful for substrates include, but are not limited to, metals, ceramics, glasses, composite materials, polymeric materials, and the like. Metals useful as substrates include, but are not limited to, aluminum and steel, such as high strength steel, stainless steel, galvanized steel, cold-rolled steel, and surface-treated metals. Surface treatments include, but are not limited to, paints, oil draw lubricants or stamping lubricants, electro-coats, powder coats, primers, chemical and physical surface treatments, and the like. Composites useful as substrates in the present disclosure include, but are not limited, to glass reinforced composites and carbon reinforced composites. Polymeric materials useful as substrates in the present disclosure include, but are not limited to nylon, polycarbonate, polyester, (meth)acrylate polymers and copolymers, acrylonitrile-butadiene-styrene copolymers, and the like.

In yet another aspect, a method of forming a cured composition is provided. The method includes providing a curable composition, heating the curable composition to release the nitrogen-containing curing agent from the composite particle, and forming a cured composition by reacting the nitrogen-containing curing agent with the epoxy resin. The curable compositions are the same as described above and include an epoxy resin and a composite particle mixed with the epoxy resin. The composite particle contains 1) a porous polymeric core, 2) a nitrogen-containing curing agent for the epoxy resin that is positioned within the porous polymeric core but not chemically bound to the porous polymeric core, and 3) a coating layer around the porous polymeric core, wherein the coating layer comprises a thermoplastic polymer, a wax, or a mixture thereof.

The formation of the composite particle containing the curing agent allows for the preparation of a one part curable composition. That is, all of the components of the curable composition can be mixed together and then heated for reactivity (i.e., formation of the cured compositions). The curable composition can be stored for at least 1 day, at least 2 days, at least 3 days, at least 1 week, at least 2 weeks, at least 1 month or more prior to formation of the cured composition. The time of curing often can be selected by controlling the temperature in which the curable composition is stored.

Embodiment 1 is a curable composition. The curable composition contains an epoxy resin and a composite particle mixed with the epoxy resin. The composite particle contains 1) a porous polymeric core, 2) a nitrogen-containing curing agent for the epoxy resin that is positioned within the porous polymeric core but not covalently bound to the porous polymeric core, and 3) a coating layer around the porous polymeric core, wherein the coating layer comprises a thermoplastic polymer, a wax, or a mixture thereof.

Embodiment 2 is the curable composition of embodiment 1, wherein the porous polymeric core comprises a crosslinked (meth)acrylate polymeric material.

Embodiment 3 is the curable composition of embodiment 1 or 2, wherein the porous polymeric core comprises a polymerized product of a reaction mixture comprising i) a first phase and ii) a second phase dispersed in the first phase, wherein a volume of the first phase is greater than a volume of the second phase. The first phase comprises either (1) water and a polysaccharide dissolved in the water or (2) a surfactant and a compound of Formula (I)

HO(—CH₂—CH(OH)—CH₂—O)ₙ—H (I)

wherein n is an integer equal to at least 1, or a mixture thereof. The second phase comprises a first monomer composition comprising (1) a monomer of Formula (II)

CH₂═C(R¹)—(CO)—O[—CH₂—CH₂—O]ₚ—(CO)—C(R¹)═CH₂ (II)

and (2) a poly(propylene glycol) having a weight average molecular weight of at least 500 grams/mole. In Formula (II), p is an integer equal to at least 1 and R¹ is hydrogen or alkyl. The poly(propylene glycol) is removed from the polymerized product to provide the porous polymeric core.

Embodiment 4 is the curable composition of any one of embodiments 1 to 3, wherein the composite particle has a core-shell configuration with the core being the porous polymeric core particle loaded with the nitrogen-containing curing agent and the shell being the coating layer.

Embodiment 5 is the curable composition of any one of embodiments 1 to 4, wherein the first phase comprises 50 to 95 weight percent water and 5 to 50 weight percent polysaccharide based on a total weight of the first phase.

Embodiment 6 is the curable composition of embodiment 5, wherein the first phase comprises 70 to 90 weight percent water and 10 to 30 weight percent polysaccharide based on a total weight of the first phase.

Embodiment 7 is the curable composition of any one of embodiments 1 to 4, wherein the first phase comprises 0.5 to 15 weight percent surfactant and 85 to 99.5 weight percent of the compound of Formula (I) based on a total weight of the first phase.

Embodiment 8 is the curable composition of embodiment 7, wherein the compound of Formula (I) is glycerol.

Embodiment 9 is the curable composition of embodiment 7 to 8, wherein the surfactant is a non-ionic surfactant.

Embodiment 10 is the curable composition of any one of embodiments 1 to 9, wherein the monomer composition comprises a second monomer of Formula (III)

CH₂═CR¹—(CO)—O—Y—R² (III)

wherein R¹ is hydrogen or methyl; Y is a single bond, alkylene, oxyalkylene, or poly(oxyalkylene); and R² is a carbocyclic group or heterocyclic group.

Embodiment 11 is the curable composition of embodiment 10, wherein the second monomer of Formula (III) is benzyl (meth)acrylate, 2-phenoxyethyl (meth)acrylate, isobornyl (meth)acrylate, tetrahydrofurfuryl (meth)acrylate, 3,3,5-trimethylcyclohexyl (meth)acrylate, or ethoxylated nonyl phenol acrylate.

Embodiment 12 is the curable composition of any one of embodiments 1 to 11, wherein the composition comprises a second monomer of Formula (III), Formula (IV), or both

CH₂═CR¹—(CO)—O—Y—R² (III)

CH₂═CR¹—(CO)—O—R³ (IV)

wherein R¹ is hydrogen or methyl; Y is a single bond, alkylene, oxyalkylene, or poly(oxyalkylene); R² is a carbocyclic group or heterocyclic group; and R³ is a linear or branched alkyl.

Embodiment 13 is the curable composition of embodiment 12, wherein the only monomers in the monomer composition are the first monomer of Formula (II) and the second monomers of Formula (III), Formula (IV), or both.

Embodiment 14 is the curable composition of embodiment 13, wherein the first monomer composition comprises 10 to 90 weight percent of the first monomer and 10 to 90 weight percent of the second monomer.

Embodiment 15 is the curable composition of embodiment 14, wherein the first monomer composition comprise 40 to 60 weight percent of the first monomer and 40 to 60 weight percent of the second monomer.

Embodiment 16 is the curable composition of any one of embodiments 1 to 15, wherein the monomer composition comprises a second monomer of Formula (VII) or a salt thereof

CH₂═CR¹—(CO)—O—R⁶—SO₃H (VII)

wherein R¹ is hydrogen or methyl; and R⁶ is an alkylene.

Embodiment 17 is the curable composition of embodiment 16, wherein the only monomers in the monomer composition are the first monomer of Formula (II) and the second monomers of Formula (III) and Formula (VII).

Embodiment 18 is the curable composition of embodiment 17, wherein the monomer composition comprises 1 to 10 weight percent of the monomer of Formula (VII) and 90 to 98 weight percent of a mixture of the monomer of Formula (II) and the monomer of Formula (III).

Embodiment 19 is the polymeric composite particle of embodiment 17, wherein the monomer composition comprises 20 to 80 weight percent monomer of Formula (II), 20 to 80 weight percent monomer of Formula (III), and 1 to 20 weight percent monomer of Formula (VII).

Embodiment 20 is the polymeric composite particle of embodiment 18, wherein the monomer composition comprises 40 to 60 weight percent monomer of Formula (II), 40 to 60 weight percent monomer of Formula (III), and 1 to 10 weight percent monomer of Formula (VII).

Embodiment 21 is the curable composition of any one of embodiments 1 to 20, wherein the composite particle comprises 20 to 90 weight percent porous polymeric core, 1 to 70 weight percent nitrogen-containing curing agent, and 10 to 80 weight percent coating layer.

Embodiment 22 is the curable composition of any one of embodiments 1 to 21, wherein the porous polymeric core has an average diameter in a range of 1 to 200 micrometers.

Embodiment 23 is the curable composition of embodiment 22, wherein the porous polymeric core has pores having an average size in a range of 1 to 200 nanometers.

Embodiment 24 is the curable composition of any one of embodiments 1 to 23, wherein the coating layer comprises a silicone-based thermoplastic polymer, (meth)acrylate-based thermoplastic polymer, olefin-based thermoplastic polymer, styrene-based thermoplastic polymer, or a phenoxy-based resin.

Embodiment 25 is the curable composition of any one of embodiments 1 to 23, wherein the coating layer comprises animal wax, vegetable wax, petroleum wax, hydrogenated vegetable oil, or polyethylene.

Embodiment 26 is the curable composition of any one of embodiments 1 to 25, wherein the coating layer has a thickness in a range of 0.1 micrometers to 5 micrometers.

Embodiment 27 is a cured composition comprising the reaction product of any one of the curable compositions of embodiments 1 to 26.

Embodiment 28 is a method of making a cured composition, the method comprising providing a curable composition of any one of embodiments 1 to 27, heating the curable composition to release the nitrogen-containing curing agent from the composite particle, and forming the cured composition by reacting the nitrogen-containing curing agent with the epoxy resin.

Embodiment 29 is the method of embodiment 28, wherein providing a curable composition comprises forming a composite particle and mixing the composite particle with the epoxy resin.

Embodiment 30 is the method of embodiment 29, wherein forming the composite particle comprises forming a porous polymeric core, positioning a nitrogen-containing curing agent with the porous polymeric core to form a loaded core particle, and depositing a coating layer around the loaded core particle.

Embodiment 31 is the method of embodiment 30, wherein depositing the coating layer comprises preparing a coating solution or a coating dispersion, mixing the loaded core particle with the coating solution or coating dispersion to form a slurry, and drying the slurry by spray drying or fluidized bed drying.

### EXAMPLES

Unless otherwise noted, all chemicals used in the examples can be obtained from the noted suppliers.

TABLE 1
List of materials and suppliers

| Material | Description |
|---|---|
| SR339 | Trade designation for 2-phenoxyethyl acrylate ester obtained from Sartomer |
| | Company, Inc. (Exton, PA, USA) |
| SR6030P | Trade designation for polyethylene glycol 400 dimethacrylate with a weight |
| | average molecular weight of 400 grams/mole obtained from Sartomer |
| | Company, Inc. (Exton, PA, USA) |
| PPG4000 | Polypropylene glycol having a weight average molecular weight of 4000 |
| | grams/mole obtained from Alfa Aesar (Ward Hill, MA, USA) |
| IRGACURE 819 | Trade designation for the photoinitiator bis(2,4,6-trimethylbenzoyl)- |
| | phenylphosphine oxide obtained from BASF (Florham Park, NJ, USA) |
| APG 325 N | Nonionic alkyl polyglucoside surfactant obtained from Cognis Corporation |
| | (Cincinnati, OH, USA) |
| IPA | Isopropyl alcohol obtained from Sigma Aldrich (St. Louis, MO, USA) |
| 2-Sulfoethyl | Monomer obtained from Scientific Polymer, Inc. (Ontario, New York, USA) |
| Methacrylate | |
| PVP | Polyvinylpyrrolidone obtained from Polysciences, Inc. (Warrington, PA, |
| | USA) having a weight average molecular weight of 40,000 grams/mole |
| PVP/VA | Copolymer of vinylpyrrolidone and vinyl acetate obtained under the trade |
| | designation SOKALAN VA64P from BASF (Florham Park, NJ); this |
| | copolymer contains 40 weight percent vinyl acetate and has a weight average |
| | molecular weight of about 65,000 grams/mole |
| OMICURE | 4,4′-Methylene bis(phenyl dimethyl urea obtained from CVC Specialty |
| U52M | Chemicals, Inc. (Moorestown, NJ, USA) |
| DMF | Dimethylformamide solvent obtained from Sigma Aldrich (St. Louis, MO, |
| | USA) |
| Ethanol | Ethanol solvent obtained from Sigma Aldrich (St. Louis, MO, USA) |
| AJICURE PN-40 | An amine adduct with epoxy resin obtained from Ajinomoto Co., Inc. (Japan) |
| DICY | Dicyandiamide, CG-1400 obtained from Air Products and Chemicals, Inc. |
| | (Allentown, PA, USA) |
| PKHP 200 | Phenoxy resin powder obtained from InChem (Rock Hill, SC, USA) that was |
| | used as a toughening agent |
| Fused Silica | MINSIL SF 20 obtained from Minco (Midway, TN, USA) |
| EPON 828 | Epoxy resin comprising the diglycidylether of bisphenol A obtained from |
| | Momentive Specialty Chemicals, Inc. (Columbus, OH, USA) |
| PARALOID | EXL-2650A butadiene rubber impact modifier that was obtained from Dow |
| 2650A | Chemical (Midland, MI, USA) |
| CUREZOL | Substituted imidazole accelerator comprised of 2-phenyl-imidazole that was |
| 2PZ-S | obtained from Air Products and Chemicals, Inc. (Allentown, PA, USA) |
| DDS | 4,4′-diaminodisulfone, commercially available under the trade designation |
| | ARADUR 9664-1 from Huntsman Advanced Materials GmbH (Basel, |
| | Switzerland) |
| Carnauba Wax | Carnauba milk emulsion obtained from Koster Keunen (Watertown, CT, |
| | USA) |
| PKHW 35 | A water-borne colloidal dispersion of phenoxy resin obtained from InChem |
| | (Rock Hill, SC, USA) |
| PKHW 34 | A water-borne colloidal dispersion of phenoxy resin obtained from InChem |
| | (Rock Hill, SC, USA) |
| HDPE | High density polyethylene emulsified, IDI R6100 obtained from The |
| | International Group, Inc. (Titusville, PA, USA) |
| LDPE | Low density polyethylene dispersion in water available under the trade |
| | designation SYNCERA LD 7410 from Paramelt (The Netherlands) |
| 1,10- | A solid diamine obtained from TCI America (Portland, OR, USA) |
| diaminodecane | |
| 1,12- | A solid diamine obtained from TCI America (Portland, OR, USA) |
| diaminododecane | |
| MX-257 | Liquid Bisphenol A Epoxy containing 37 ± 1% core-shell rubber obtained |
| | from Kaneka Texas Corporation (Pasadena, TX, USA) |
| MX-615 | Di-allyl Bisphenol A Epoxy containing 25% core-shell rubber obtained from |
| | Kaneka Texas Corporation (Pasadena, TX, USA) |
| KANE ACE | Polybutadiene-poly(methyl methacrylate) core-shell rubber particles obtained |
| B-564 | from Kaneka Corporation (Japan) |
| ERISYS GE-11 | Epoxidized para-tertiary butyl phenol, an aromatic mono-epoxide obtained |
| | from CVC Specialty Chemicals, Inc. (Moorestown, NJ, USA) |
| PLASTOMOLL | An adipic acid ester with less branched isononanols (diisononyl adipate) that |
| DNA | was obtained from BASF (Florham Park, NJ, USA) that was used as a |
| | plasticizer |
| BMI | 1,1′-(methylenedi-4,1-phenylene)bismaleimide from Sigma Aldrich (St. |
| | Louis, MO, USA) that was used as an additional curative for epoxy resin |
| | compositions |
| PES | Polyethersulfone obtained from BASF (Florham Park, NJ, USA) under the |
| | trade designation ULTRASON E 2020 P SR MICRO. The weight average |
| | molecular weight was 55,000 gram/mole |

### Test Methods

### Differential Scanning Calorimetry (DSC)

Small samples of epoxy mixtures were prepared to determine the thermal properties of the particles through differential scanning calorimetry (DSC) experiments. Compositions were prepared by weighing out EPON 828 Resin into small Dac plastic containers, then adding accelerators and other fillers to the containers. Samples were Dac mixed (SPEEDMIXER DAC 150.1 FV, Flacktek, Inc.) at 3000 RPM for 1 min. Then, samples were weighed into DSC pans for analysis.

DSC was performed on a MODEL Q2000 DSC instrument (TA Instruments Inc., New Castle, Del., USA). DSC samples were typically 6 to 20 milligrams. Testing was done in sealed, aluminum, T-zero sample pans, by heating at a rate of 5° C./min from room temperature (25° C.) to 300° C. The data from the reaction process was graphed on a chart showing heat flow versus temperature. The integrated area under an exothermic peak represented the total exotherm energy produced during the reaction and was measured in Joules/gram (J/g); the exotherm energy was proportional to extent of cure (that is, degree of polymerization). The exotherm profile (that is, the onset temperature (the temperature at which reaction will begin to occur), the peak temperature, and the end temperature) provided information on conditions needed to cure the sample.

### Overlap Shear Strength (“OLS”)

Overlap shear strength of each adhesive film formulation was measured by bonding 25 mm×100 mm×1.6 mm steel coupons into test specimens as described in ASTM 1002-01. The steel coupons used for measuring shear strength were cold-rolled steel (obtained from Q-Lab Corp., Westlake, Ohio, USA under the trade designation “Q-PANEL, RS-14”) or etched aluminum (obtained from Q-Lab Corp., Westlake, Ohio, USA under the trade designation “Q-PANEL, 2024T3 bare”). The steel coupons were prepared by wiping them with acetone and allowing them to air-dry for five minutes. The adhesives were applied and the two steel coupons were mated together (total thickness of the adhesive film was approximately 250 micrometers) by using 10 mil (about 254 micrometers or 0.010 inches) glass beads as spacers, then clamped in place using disposable binder clips. Upon curing, the clips were removed. Overlap shear specimens were clamped into the jaws of a tensile tester (INSTRON, MODEL 5581 equipped with a 10,000 pounds (about 4536 kilograms) load cell) and pulled apart to bond failure at a crosshead speed of 12.5 millimeters (mm) per minute. Results were reported in megapascals (MPa).

### T-Peel Adhesion Test

T-Peel bonds were measured on 1 inch (approximately 2.5 cm) wide specimens cut from two FPL etched 8 inches×8 inches×0.032 inches aluminum panels bonded together with the adhesive being evaluated. The separation note of the testing jaws was 20 inches/minute. Tests were run according to ASTM D1876-08 and data is given in kg/cm and pounds per inch width (PIW).

The aluminum panels are 2024T3 grade aluminum purchased from Q-Lab (Westlake, Ohio, USA). The FPL process to prepare the aluminum substrates for bonding that was developed by Forest Products Laboratory. The process involved soaking the aluminum specimens in a caustic wash solution such as ISOPREP 44, which is commercially available from Martin Aerospace (Los Angeles, Calif., USA), at a temperature of 160° F.±10° F. (about 70° C.). Then the specimens were placed in a rack and submerged in a tank of tap water for 10 minutes. The specimens were then spray rinsed with tap water for 2 to 3 minutes. Next, the specimens were soaked at 150° F. (about 66° C.) for 10 minutes in a tank of FPL etch, which is a hot solution of sulfuric acid, sodium dichromate, and aluminum as described in section 7 of ASTM D-2651-01 (2008). The etched specimens are spray rinsed with tap water for 3 to 5 minutes and drip dried for 10 minutes at ambient temperature and for 30 minutes in a re-circulating air oven at 150° F. (about 66° C.).

### Preparatory Example 1 (PE-1)

The monomers SR339 (50 grams), SR6030P (50 grams), and 2-sulfoethyl methacrylate (5 grams) were mixed with PPG4000 (43 grams) and IRGACURE 819 (250 milligrams). The mixture was stirred vigorously for 20 minutes at about 40° C. to 50° C. This mixture was then added to 250 grams of glycerol previously mixed with 7.5 grams of the surfactant APG 325 N. The mixture was shear mixed for 20 minutes. The mixture was then spread thin between two sheets of polyethylene terephthalate (PET) and cured with ultraviolet light for 10 to 15 minutes with a 100 Watts, long-wavelength BLACK RAY UV lamp (obtained from UVP, LLC of Upland, Calif., USA) situated at about 15 centimeters (about 6 inches) from the surface of the curing material.

The cured mixture was then dispersed in excess water (500 mL), shaken for 30 minutes, and centrifuged at 3000 revolutions per minute (rpm) in an EPPENDORF 5810 R centrifuge (obtained from Eppendorf in Germany). The supernatant was removed and the resulting particles were then re-suspended in 500 mL of water for a second rinse followed by centrifugation. The particles were suspended in a 500 mL IPA and shaken for 20 minutes. This procedure extracted the polypropylene glycol and left voids (i.e., pores or free volume) in the particles. The particles were then centrifuged at 300 rpm for 30 minutes and the supernatant was discarded. The particles were oven-dried overnight at 70° C. to eliminate any IPA left in the mixture. Scanning electron microscopy (SEM) images of the particles were as shown in FIGS. 1A and 1B.

### Preparatory Example 2 (PE-2)

50 grams of SR339 and 50 grams of SR6030P were mixed with 43 grams of PPG and 250 milligrams of IRGACURE 819. The mixture was stirred vigorously for 20 minutes while heating from 40 to 50° C. This second phase mixture was then added to a first phase that contained 750 grams of glycerol that had previously been mixed with 7.5 grams of APG 325. The mixture was then shear mixed for 20 minutes using a shear mixer at 700 rpm, spread between two sheets of a polyethylene terephthalate (PET) film, and cured for 15 to 20 minutes with a 100 Watt, long-wavelength BLACK RAY UV lamp (obtained from UVP, LLC of Upland, Calif., USA) positioned approximately 15 centimeters above the material.

The cured mixture was then dispersed in 500 milliliters of water, shaken vigorously for 30 minutes, and centrifuged at 3000 rpm in an EPPENDORF 5810 R centrifuge (obtained from Eppendorf International, Hauppauge, N.Y., USA) for 30 minutes. The supernatant was removed and the resulting particles were re-suspended in 500 milliliters of water and subsequently centrifuged again. The supernatant was then removed and the particles were suspended in 500 milliliters of isopropyl alcohol and shaken for 20 minutes. The mixture was centrifuged again to isolate the particles and the supernatant was discarded.

### Example 1 (EX-1)

Dry particles from PE-1 (50 grams) (“core particle”) were combined with a solution of 17.5 grams of OMICURE U52M (see Table 2) dissolved in 175 grams of DMF. The particles were then dried under an infrared lamp overnight. Next, the dried OMICURE U52M-containing particles (“loaded core particle”) were added to 2 liters of distilled water and 53.5 grams of PVP as a “shell material” (see Table 2) and further mixed with an ultrasonic probe. The resulting polymer mixture was then used as the precursor slurry for spray drying to microencapsulate the particles by coating a PVP polymer shell around the OMICURE U52M-containing particles.

The slurry created as outlined above was dried with a customized MODEL 48 mixed flow spray dryer fabricated by Spray Drying Systems, Inc. (headquartered in Eldersburg, Md., USA). The spray dryer was 4 feet (about 1.2 meters) in diameter and had 8 foot (about 2.4 meters) straight sides. Room air was provided as the bulk drying gas, which was then heated and carried through the drying chamber (entered through the top and exited through the bottom) and finally to a cyclone and a baghouse before being exhausted. The cyclone separated the product solids from the gas stream, and can separate particles down to approximately 1 micron in diameter. The bulk drying gas temperature at the chamber inlet was 76° C. to 86° C., and at the outlet was 58° C. to 49° C. The slurry was provided at 27 grams per minute via a peristaltic pump. The slurry was atomized vertically upward utilizing internal mix two-fluid pressure spray atomizing nozzles (available from Spraying Systems Co. (Wheaton, Ill., USA) under the trade designations “FLUID CAP 1650” and “AIR CAP 1891125”). The atomizing gas was nitrogen, provided at 3.3 SCFM.

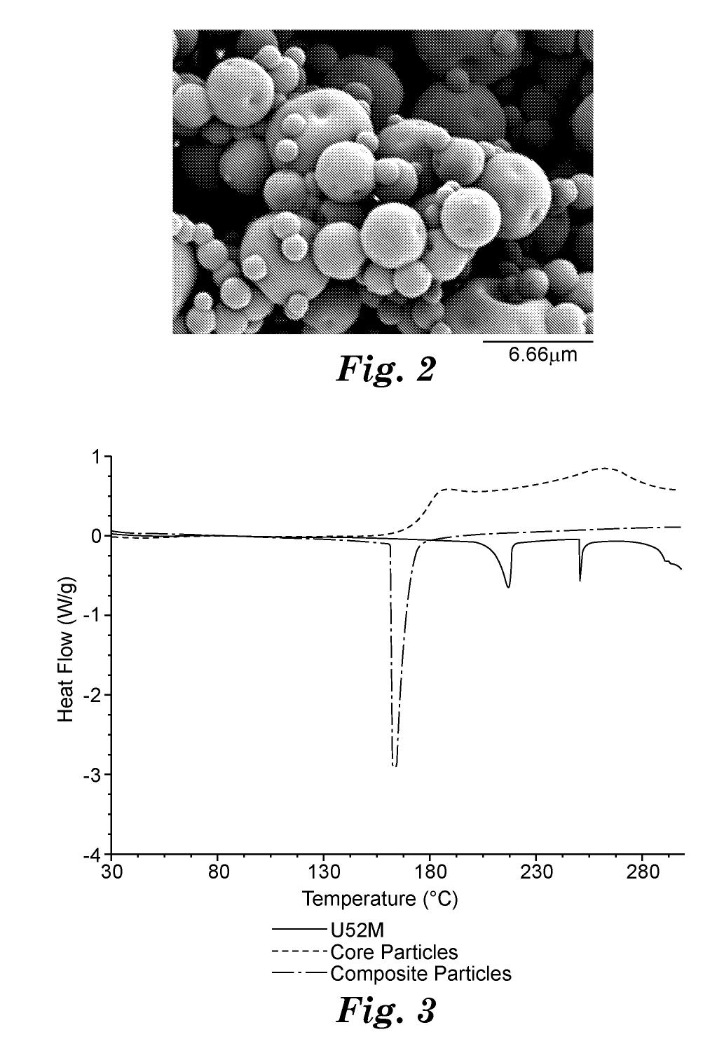

Scanning electron microscopy (SEM) images of the composite particles resulting from the procedure of EX-1 were as shown in FIG. 2.

DSC measurements of heat flow versus temperature were made to compare the U52M curing agent (U52M alone), the core particle of PE-1, and the U52M-filled and coated particles of EX-1 (composite particles of EX-1), with results as shown in FIG. 3. The plot for the U52M curing agent alone shows its melting point. The plot for the core particle of PE-1 shows the decomposition of the polymeric material. The plot for the composite particle of EX-1 shows the melting point of the thermoplastic coating of the composite particle.

The conditions used to prepare this example are summarized in Table 2.

### Example 2 (EX-2)

Dry particles from PE-1 (50 grams) core particle were combined with a solution of 5 grams of AJICURE PN-40 (see Table 2) dissolved in 50 grams of DMF. The particles were then dried under an infrared lamp overnight. Next, 20 grams of the dried particles (loaded core particle) were added to 1 liter of distilled water and 25 grams of PVP and further mixed with an ultrasonic probe. The resulting polymer mixture was then used as the precursor slurry for spray drying to microencapsulate the particles (to form the composite particles).

The particles were spray dried using a MINI-PROBE B-190 cyclone spray dryer (available from Buchi) at a flow rate of 10 RPM and an inlet temperature set at 190° C. (outlet reading of 101-108° C.). The conditions used to prepare this example are summarized in Table 2.

### Example 3 (EX-3)

Dry particles from PE-1 (80 grams) core particle were combined with a solution of 50 g CUREZOL 2PZ-S dissolved in 200 grams of acetone. The particles were then dried overnight at 60° C. Next, 20 grams of the dry particles (loaded core particle) were added to 600 grams of distilled water and 212 grams of PVP and further mixed with an ultrasonic probe. The resulting polymer mixture was then used as the precursor slurry for spray drying to microencapsulate the particles, using a similar procedure as in EX-1, except using the spray dryer in closed loop mode (the system is purged with nitrogen, which is recycled during operation; instead of exhausting the bulk drying gas after it passes through the baghouse, it is run through a condenser and then input into the heater to be reused). The Fluid Cap 100150 and Air Cap 170 were used. The inlet drying gas temperature was 87° C. while the outlet drying gas temperature was approximately 62° C. Atomizing nitrogen was provided at 1.6 SCFM and the slurry was provided at 40 grams per minute. The conditions used to prepare this example are summarized in Table 2.

### Example 3a (EX-3a)

For EX-3a, the procedure of EX-3 was followed except that CARNAUBA WAX was used in place of PVP. The spray drying conditions used are as follows: Fluid Cap 60100, Air Cap 170, inlet drying gas temperature of 104° C., outlet drying gas temperature of 60° C., atomizing nitrogen provided at 3.5 SCFM, and slurry provided at 65 grams per minute. The conditions used to prepare this example are summarized in Table 2.

### Example 3b (EX-3b)

For EX-3b, the procedure of EX-3 was followed except that PKHW-34 phenoxy material was used in place of PVP. The spray drying conditions used are as follows: Fluid Cap 60100, Air Cap 170, inlet drying gas temperature of 98° C., outlet drying gas temperature of 61° C., atomizing nitrogen provided at 4.5 SCFM, and slurry provided at approximately 50 grams per minute. The conditions used to prepare this example are summarized in Table 2.

### Example 4 (EX-4)

Dry particles from PE-1 (80 grams) (core particle) were combined with a solution of 40 g DDS in 100 g of acetone. The particles were then dried overnight at 60° C. Next, the dried particles (loaded core particle) were added to 600 grams of distilled water and 212 grams PVP and further mixed with an ultrasonic probe. The resulting polymer mixture was then used as the precursor slurry for spray drying to microencapsulate the particles (in the same way as in Example 3) by coating a 2 micrometer polymer shell around the DDS-containing particles. The spray drying conditions used are as follows: Fluid Cap 60100, Air Cap 170, inlet drying gas temperature of approximately 96° C., outlet drying gas temperature of approximately 55° C., atomizing nitrogen provided at 3.5 SCFM, and slurry provided at approximately 53 grams per minute. The conditions used to prepare this example are summarized in Table 2.

### Example 4a (EX-4a)

For EX-4a, the procedure of EX-4 was followed except that PVP/VA was used in place of PVP. The spray drying conditions used are as follows: Fluid Cap 100150, Air Cap 170, inlet drying gas temperature of approximately 97° C., outlet drying gas temperature of 57° C., atomizing nitrogen provided at 1.5 SCFM, and slurry provided at approximately 40 grams per minute. The conditions used to prepare this example are summarized in Table 2.

### Example 4b (EX-4b)

For EX-4b, the procedure of EX-4 was followed except that CARNAUBA WAX was used in place of PVP. The spray drying conditions used are as follows: Fluid Cap 60100, Air Cap 170, inlet drying gas temperature of approximately 110° C., outlet drying gas temperature of approximately 60° C., atomizing nitrogen provided at 3.4 SCFM, and slurry provided at approximately 50 grams per minute. The conditions used to prepare this example are summarized in Table 2.

### Example 4c (EX-4c)

For EX-4c, the procedure of EX-4 was followed except that PKHW-35 was used in place of PVP. The spray drying conditions used are as follows: Fluid Cap 60100, Air Cap 170, inlet drying gas temperature of 106° C., outlet drying gas temperature of 56° C., atomizing nitrogen provided at 3.4 SCFM, and slurry provided at approximately 40 grams per minute. The conditions used to prepare this example are summarized in Table 2.

### Example 5 (EX-5)

Dry particles from PE-1 (80 grams) core particle were combined with a solution of 40 grams of 1,10-diaminodecane in 100 g of ethanol. The particles were then dried overnight at 60° C. Next, the dried particles (loaded core particle) were added to 600 grams of distilled water and 212 grams of CARNAUBA WAX and further mixed with an ultrasonic probe. The resulting polymer mixture was then used as the precursor slurry for spray drying to microencapsulate the particles (in the same way as in Example 3). The spray drying conditions used are as follows: Fluid Cap 60100, Air Cap 170, inlet drying gas temperature of 106° C., outlet drying gas temperature of 59° C., atomizing nitrogen provided at 3.4 SCFM, and slurry provided at 60 grams per minute. The conditions used to prepare this example are summarized in Table 2.

### Example 5a (EX-5a)

For EX-5a, the procedure of EX-5 was followed except that LDPE was used in place of CARNAUBA WAX. The spray drying conditions used are as follows: Fluid Cap 60100, Air Cap 170, inlet drying gas temperature of 107° C., outlet drying gas temperature of approximately 66° C., atomizing nitrogen provided at 3.6 SCFM, and slurry provided at approximately 40 grams per minute. The conditions used to prepare this example are summarized in Table 2.

### Example 5b (EX-5b)

For EX-5b, the procedure of EX-5 was followed except that HDPE was used in place of CARNAUBA WAX. The spray drying conditions used are as follows: Fluid Cap 60100, Air Cap 170, inlet drying gas temperature of 109-112° C., outlet drying gas temperature of 60-57° C., atomizing nitrogen provided at 4.1 SCFM, and slurry provided at approximately 55 grams per minute. The conditions used to prepare this example are summarized in Table 2.

### Example 6 (EX-6)

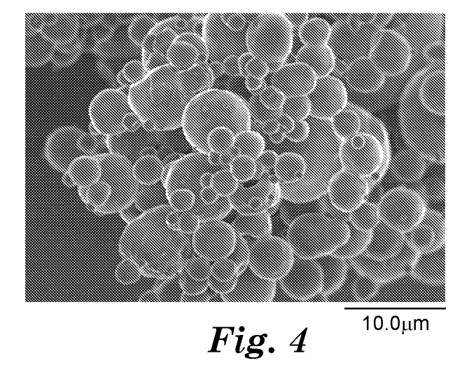

For EX-6, the procedure of EX-5b was followed except that 1,12-diaminodecane was used in place of 1,10-diaminodecane, and PE-2 was used as the core particles. The spray drying was done using similar conditions to those used in EX-2. SEM of the resulting coated particles are shown in FIG. 4. The conditions used to prepare this example are summarized in Table 2.

TABLE 2

| | | | | Mass | | | | |
|---|---|---|---|---|---|---|---|---|
| | | | Mass | Solids | Mass | | | |
| | | | Solids | in | Water | Mass | Particle | |
| | | Shell | in | Shell | used for | Loaded | Diameter | |
| | Shell | Tg/Tm, | Slurry, | Mix, | Dilution, | Particles, | Size, | Curing |
| Sample | material | ° C. | wt. % | grams | grams | grams | micrometers | agent |
| EX-1 | PVP | 140 | 33 | 50 | 0 | 17.5 | 30-40 | OMICURE |
| | | | | | | | | U52M |
| EX-2 | PVP | 140 | 4.3 | 1025 | 0 | 5 | 30-40 | AJICURE |
| | | | | | | | | PN-40 |
| EX-3 | PVP | 140 | 48 | 406 | 0 | 80 | 30-40 | 2PZ-S |
| EX-3a | WAX | 85-90 | 44 | 200 | 0 | 50 | 30-40 | 2PZ-S |
| EX-3b | PKHW 34 | 100 | 35 | 225 | 70 | 44 | 30-40 | 2PZ-S |
| EX-4 | PVP | 140 | 33 | 508 | 0 | 50 | 30-40 | DDS |
| EX-4a | PVP/VA | 110-120 | 42 | 360 | 0 | 100 | 30-40 | DDS |
| EX-4b | WAX | 85-90 | 13 | 172 | 500 | 43 | 30-40 | DDS |
| EX-4c | PKHW 35 | 91 | 38 | 415 | 85 | 81 | 30-40 | DDS |
| EX-5 | WAX | 85-90 | 44 | 310 | 0 | 80 | 30-40 | 1,10- |
| | | | | | | | | Diaminedecane |
| EX-5a | LDPE | 110-120 | 47 | 589 | 0 | 84 | 30-40 | 1,10- |
| | | | | | | | | diaminodecane |
| EX-5b | HDPE | 127 | 19 | 141 | 743 | 154 | 30-40 | 1,10- |
| | | | | | | | | diaminodecane |
| EX-6 | HDPE | 127 | 30 | 360 | 83 | 15 | 10 | 1,12- |
| | | | | | | | | diaminododecane |

In Table 2, CARNAUBA WAX is referred to simply as WAX. The Tg/Tm (glass transition temperature or melting temperature) for the shell was obtained from the vendor of the thermoplastic material or wax. The “Mass Solids in Slurry, wt. %” was based on the total weight of the loaded particles plus the weight of the wax or polymers used to form the shell. The “Mass Solids in Shell Mix, grams” was based on the total weight of the wax or polymer used to form the shell.

### Comparative Example 1 (CE-1)

An epoxy film formulation was prepared, including the urea material OMNICURE U52M but lacking the coated particles of EX-1, by combining materials in the amounts listed in Table 3.

### Example 7 (EX-7)

An epoxy film formulation containing the OMNICURE U52M-filled, PVP-encapsulated particles of EX-1 was prepared, by combining materials in the amounts listed in Table 3.

TABLE 3

| Materials, grams | CE-1 | EX-7 |
|---|---|---|
| EPON 828 resin | 54 | 54 |
| PARALOID 2650A | 14 | 14 |
| PKHP 200 | 15.4 | 15.4 |
| Fused Silica | 12 | 12 |
| DICY | 3.3 | 3.3 |
| OMNICURE U52M | 1.3 | 0 |
| OMNICURE U52M-filled | 0 | 2.2 |
| capsules from EX-1 | | |

The film formulation samples of CE-1 and EX-7 were observed and tested, with results as summarized in Table 4.

TABLE 4

| Conditions/Testing | CE-1 | EX-7 |
|---|---|---|
| Physical form of film at 24° C. | Soft | Soft |
| Physical form of film after 7 days at 40° C. | Dry | Soft |
| Physical form of film after 2 days at 70° C. | Rigid | Soft |
| OLS on steel, prior to storage at 40° C. | 17 MPa | 16 MPa |
| OLS on steel, after storage at 40° C. for 7 days | 8 MPa | 17 MPa |

### Example 8 (EX-8), Example 9 (EX-9), Comparative Example 2 (CE-2), and Comparative Example 3 (CE-3)

Particles from EX-2 (filled with AJICURE PN-40 and coated with PVP) were combined with EPON 828 resin and DICY in the amounts shown in Table 5. Example 9 (EX-9) and comparative examples CE-2 and CE-3 were prepared following the procedure for EX-8, but using the materials and amounts listed in Table 5.

TABLE 5

| Materials, grams | EX-8 | CE-2 | EX-9 | CE-3 |
|---|---|---|---|---|
| EPON 828 resin | 1 | 1 | 1 | 1 |
| DICY | 0.03 | 0.03 | 0.03 | 0.03 |
| OMNICURE U52M-filled capsules from | 0 | 0 | 0.025 | 0 |
| EX-1 | | | | |
| OMNICURE U52M | 0 | 0 | 0 | 0.01 |
| AJICURE PN-40 filled capsules from | 0.025 | 0 | 0 | 0 |
| EX-2 | | | | |
| AJICURE PN-40 | 0 | 0.01 | 0 | 0 |

DSC aging studies of EX-8, EX-9, CE-2, and CE-3 were performed to determine the temperature at which reaction began to occur (i.e., onset temperature for reaction (“Onset T”)) and total exotherm energy (i.e., heat of reaction, “AH Rxn”), with results as summarized in Table 6.

TABLE 6
DSC aging data for epoxy formulations with and without
encapsulated particles

| | | | Total exotherm |
|---|---|---|---|
| Sample | Aging, weeks | Onset T, ° C. | energy, J/gram |
| EX-8 | 0 | 162 | 303 |
| | 1 | 160 | 313 |
| | 2 | 159 | 304 |
| | 3 | 158 | 281 |
| | 4 | 157 | 336 |
| | 5 | 158 | 289 |
| CE-2 | 0 | 130 | 265 |
| | 1 | 130 | 156 |
| | 2 | 127 | 273 |
| | 3 | 127 | 210 |
| | 4 | 128 | 200 |
| | 5 | 128 | 193 |
| EX-9 | 0 | 155 | 245 |
| | 1 | 156 | 255 |
| | 2 | 155 | 233 |
| | 3 | 153 | 210 |
| | 4 | 153 | 242 |
| | 5 | 153 | 242 |
| CE-3 | 0 | 136 | 258 |
| | 1 | 129 | 221 |
| | 2 | 127 | 248 |
| | 3 | 121 | 163 |
| | 4 | 117 | 220 |
| | 5 | 115 | 167 |

### Example 10 (EX-10)

A one-part epoxy adhesive paste formulation containing the 2PZ-S-filled, PVP-encapsulated particles of EX-3 was prepared, by combining materials in the amounts listed in Table 7.

TABLE 7

| Materials, grams | EX-10 |
|---|---|
| EPON 828 resin | 50 |
| ERISYS GE-11 | 15 |
| PLASTOMOLL DNA | 10 |
| KANEACE B-564 | 20 |
| CUREZOL 2PZ-S-FILLED | 5 |
| CAPSULES from EX-3 | |

EX-10 was prepared, cured at 250° F. (121° C.) for 1 hour, and then tested, with results as summarized in Table 8.

TABLE 8

| Conditions/Testing | EX-10 | |
|---|---|---|
| OLS at room temperature, 24° C. | 19.3 | MPa |
| OLS at 82° C. (180° F.) | 20.7 | MPa |
| T-peel at room temperature, 24° C. | 0.72 | kg/cm |
| | (4 | PIW) |

### Comparative Examples 4 and 5 (CE-4 and CE-5)

Two epoxy film formulations were prepared, including DDS as a curative but lacking the coated particles of EX-4b, by combining materials in the amounts listed in Table 9.

### Example 11 (EX-11) and Example 12 (EX-12)

Two epoxy film formulations were prepared, including encapsulated DDS particles of EX-4b, by combining materials in the amounts listed in Table 9. The samples of CE-4, CE-5, EX-11, and EX-12 were prepared, cured at 250° F. (121° C.) for 1 hour, and then tested, with results as summarized in Table 9. The shelf life was also reported over time, leaving the films at room temperature.

TABLE 9

| Materials, | | | | |
|---|---|---|---|---|
| grams | CE-4 | EX-11 | EX-12 | CE-5 |
| MX-257 | 38 | 38 | 19 | 19 |
| BMI | 12 | 12 | 12 | 12 |
| PES | 12 | 12 | 12 | 12 |
| EX-4b | | 10.5 | 10.5 | |
| DDS | 10.1 | | | 10.5 |
| MX-615 | 12 | 12 | | |
| Shelf life, at | Film becomes brittle and | Film remains tacky | Film remains tacky | Film becomes |
| 24° C. | cracks when handling in | and flexible after | and flexible after | brittle and cracks |
| | less than 3 days | two months | two months | after 10 days |
| OLS, PSI, | 6494 (44.8) | 1146 (7.9) | 1990 (13.7) | 5409 (37.3) |
| (MPa) at 24° C. | | | | |

### Examples 13-15 (EX-13, EX-14, and EX-15) and Comparative Examples 6, 7, and 8 (CE-6, CE-7, and CE-8): Model Epoxy System Loaded with Diamine-Filled Particles

Particles from EX-5b and EX-6 (filled with 1,12-diaminododecane and coated with HDPE) were combined with EPON 828 resin in the amounts shown in Table 10. CE-6, CE-7 and CE-8 are samples with the amines at equivalent amounts but not encapsulated. Overlap shear specimens were prepared on aluminum substrates and cured at 180° C. for 10 minutes. The results are shown in Table 10 from testing these samples.

TABLE 10

| Materials, grams | EX-13 | CE-6 | EX-14 | CE-7 | EX-15 | CE-8 |
|---|---|---|---|---|---|---|
| EPON 828 resin | 1 | 1 | 1 | 1 | 1 | 1 |
| 1,10-diaminodecane-filled | 0.3 | 0 | 0.4 | 0 | 0 | 0 |
| capsules from EX-5b | | | | | | |
| 1,10-diaminodecane | 0 | 0.075 | 0 | 0.1 | 0 | 0 |
| 1,12-diaminododecane-filled | 0 | 0 | 0 | 0 | 0.2 | 0 |
| capsules from EX-6 | | | | | | |
| 1,12-diaminododecane | 0 | 0 | 0 | 0 | 0 | 0.02 |
| OLS Strength on Aluminum, | 232 (1.6) | 162 (1.1) | 320 (2.2) | 573 (3.9) | 347 (2.4) | 170 (1.2) |
| PSI (MPa) | | | | | | |

1. A curable composition comprising:
a. an epoxy resin; and
b. a composite particle mixed with the epoxy resin, wherein the composite particle comprises
i. a porous polymeric core particle;
ii. a nitrogen-containing curing agent for the epoxy resin positioned within the porous polymeric core particle but not covalently bound to the porous polymeric core particle;
iii. a coating layer around the porous polymeric core particle, wherein the coating layer comprises a thermoplastic polymer, a wax, or a mixture thereof.

2. The curable composition of claim 1, wherein the porous polymeric core particle comprises a crosslinked (meth)acrylate polymeric material.

3. The curable composition of claim 1, wherein the porous polymeric core comprises a polymerized product of a reaction mixture comprising
i. a first phase comprising either
1) water and a polysaccharide dissolved in the water; or
2) a surfactant and a compound of Formula (I)
HO(—CH₂—CH(OH)—CH₂—O)ₙ—H (I)
wherein n is an integer equal to at least 1, or a mixture thereof; and
ii. a second phase dispersed in the first phase, wherein a volume of the first phase is greater than a volume of the second phase and wherein the second phase comprises
1) a first monomer composition comprising a monomer of Formula (II)
CH₂═C(R¹)—(CO)—O[—CH₂—CH₂—O]ₚ—(CO)—C(R¹)═CH₂ (II)
wherein
p is an integer equal to at least 1;
R¹ is hydrogen or alkyl; and
2) a poly(propylene glycol) having a weight average molecular weight of at least 500 grams/mole,
wherein the poly(propylene glycol) is removed from the polymerized product to provide the porous polymeric core.

4. The curable composition of claim 1, wherein the composite particle has a core-shell configuration with the core being the porous polymeric core particle loaded with the nitrogen-containing curing agent and the shell being the coating layer.

5. The curable composition of claim 3, wherein the first phase comprises 50 to 95 weight percent water and 5 to 50 weight percent polysaccharide based on a total weight of the first phase.

6. The curable composition of claim 1, wherein the first phase comprises 0.5 to 15 weight percent surfactant and 85 to 99.5 weight percent of the compound of Formula (I) based on a total weight of the first phase.

7. The curable composition of claim 1, wherein the monomer composition comprises a second monomer of Formula (III)
CH₂═CR¹—(CO)—O—Y—R² (III)
wherein
R¹ is hydrogen or methyl;
Y is a single bond, alkylene, oxyalkylene, or poly(oxyalkylene); and
R² is a carbocyclic group or heterocyclic group.

8. The curable composition of claim 1, wherein the monomer composition comprises a second monomer of Formula (VII) or a salt thereof
CH₂═CR¹—(CO)—O—R⁶—SO₃H (VII)
wherein
R¹ is hydrogen or methyl; and
R⁶ is an alkylene.

9. The curable composition of claim 1, wherein the composite particle comprises 20 to 90 weight percent porous polymeric core particle, 1 to 70 weight percent nitrogen-containing curing agent, and 10 to 80 weight percent coating layer.

10. A cured composition comprising the reaction product of a curable composition comprising:
a. an epoxy resin; and
b. a composite particle mixed with the epoxy resin, wherein the composite particle comprises
i. a porous polymeric core;
ii. a nitrogen-containing curing agent for the epoxy resin positioned within the porous polymeric core but not covalently bound to the porous polymeric core;
iii. a coating layer around the porous polymeric core, wherein the coating layer comprises a thermoplastic polymer, a wax, or a mixture thereof.

11. A method of making a cured composition, the method comprising:
a. providing a curable composition comprising
i. an epoxy resin; and
ii. a composite particle mixed with the epoxy resin, wherein the composite particle comprises
1) a porous polymeric core;
2) a nitrogen-containing curing agent for the epoxy resin positioned within the porous polymeric core but not covalently bound to the porous polymeric core; and
3) a coating layer around the porous polymeric core, wherein the coating layer comprises a thermoplastic polymer, a wax, or a mixture thereof;
b. heating the curable composition to release the nitrogen-containing curing agent from the composite particle; and
c. forming a cured composition by reacting the nitrogen-containing curing agent with the epoxy resin.
